(19) United States
(12) Patent Application Publication
(10) Pub. No.: US 2025/0376422 A1
(43) Pub. Date: Dec. 11, 2025

(54) SULFUR-INCORPORATED BISMUTH FERRITE NANOPARTICLES AND A METHOD OF PREPARATION THEREOF

(71) Applicant: KING FAHD UNIVERSITY OF PETROLEUM AND MINERALS, Dhahran (SA)

(72) Inventors: Mohamed Jaffer Sadiq MOHAMED, Dhahran (SA); Muhammad Ashraf GONDAL, Dhahran (SA)

(73) Assignee: KING FAHD UNIVERSITY OF PETROLEUM AND MINERALS, Dhahran (SA)

(21) Appl. No.: 18/736,040

(22) Filed: Jun. 6, 2024

(51) Int. Cl. C04B 35/26; B01J 35/39; B82Y 40/00; C04B 35/626; C25B 1/04; C25B 11/042

(52) U.S. Cl. CPC C04B 35/26; B01J 35/39; B82Y 40/00; C04B 35/6265; C25B 1/04; C25B 11/042; C04B 2235/3274; C04B 2235/5454; C04B 2235/96

(57) ABSTRACT

Sulfur-incorporated bismuth ferrite nanoparticles (SBFNPs) contain Bi₂Fe₄O₉ nanoparticles doped with Fe(0) and Bi(0) and sulfur in an amount of 0.5 to 5 percent by weight. At least a portion of bismuth is bonded to at least a portion of the sulfur and at least a portion of iron is bonded to at least a portion of the sulfur. The bismuth ferrite nanoparticles have a longest dimension of 1 to 50 nm. A method of photocatalytic degradation of dyes and a method of hydrogen generation and storage using the nanoparticles.

### STATEMENT REGARDING PRIOR DISCLOSURE BY THE INVENTORS

Aspects of the present disclosure are described in Gondal, M. A. and Mohamed, M. J. S., “Synthesis of sulfur-encapsulated mullite structure Bi⁰/Fe⁰-Rich Bi₂Fe₄O₉₋ₓ framework by advanced probe sonic approach applied for augmented electroactive hydrogen production, storage and photoactive degradation studies” published in Volume 978, Journal of Alloys and Compounds, which is incorporated herein by reference in its entirety.

### STATEMENT OF ACKNOWLEDGEMENT

Support provided by King Fahd University of Petroleum and Minerals, Saudi Arabia, through Project H2FC2305 is gratefully acknowledged.

### BACKGROUND

### Technical Field

The present disclosure is directed to bismuth ferrite nanoparticles, particularly sulfur-incorporated bismuth ferrite nanoparticles, for photocatalytic degradation of dyes and for generation and storage of hydrogen.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Organic dyes in water are toxic, even at low concentrations, posing a hazard to aquatic ecosystems. Discharges of wastewater from the tanneries, fabric mills, paper mills, and pulp mills generate large amounts of different hazardous biological wastes, such as methylene-blue (MB), rhodamine B (RB), methyl-orange (MO), and the like. These dyes are toxic to the environment due to the fact that they are non-biodegradable chemical wastes. Conventional biological treatment of dye-containing industrial wastewater may be a more effective treatment method; however, biological treatment may also result in dark industrial wastewater. Presently, excessive use of various non-biodegradable dyes in various industries is becoming a source of groundwater contamination. Every year, over 450,000 tons of organic dyes are manufactured and consumed globally, accounting for almost 11% of the environmental harm [T. Z. T. Ting, J. A. Stagner, Fast fashion-wearing out the planet, Int J Environ Studies. (2021) 1-11]. New methods using dye-degrading technology are needed to address these issues.

Photocatalytic degradation, electrochemical treatment, biological treatment, chemical oxidation, ion-exchange, flocculation, coagulation, and membrane processes have been used to purify wastewater containing organic dyes [M. Motamedi, L. Yerushalmi, F. Haghighat, Z. Chen, Recent developments in photocatalysis of industrial effluents: A review and example of phenolic compounds degradation, Chemosphere. (2022) 133688]. Photocatalysis is an effective method for wastewater treatment and decolorization. Photocatalysis is emerging as an area of scientific and industrial application, leading to the development of innovative and environmentally friendly nanoscale materials. Semiconductor-based photocatalysts may absorb photons and generate electron-hole (e⁻-h⁺) pairs that can subsequently be used to reduce or oxidize the surface of the photocatalytic material. Photocatalysts have the potential application for environmental remediation through pollutant degradation via electron-hole pair generation.

Studies have been conducted on bismuth-based compounds due to their unique photocatalytic properties, appropriate optical band gap energy (E_{g}), and excellent chemical stability. Pure bismuth ferrite (BF) is an active photocatalyst for visible light with an E_{g} ranging from 1.8 eV to 2.2 eV. Pure bismuth ferrite is gaining popularity due to its multi-ferric, magnetic, and sensing capabilities. It exhibits high photocatalytic activity under visible light to degrade a wide range of environmental contaminants; however, the degradation efficiency of pure BF is restricted owing to its high (e⁻-h⁺) pairs recombination rate, which needs further improvement. As a result, a current challenge is to develop highly efficient photocatalysts that react to visible light.

Various non-metallic elements, such as nitrogen, carbon, sulfur, and iodine, have been investigated to improve the photocatalytic performance of semiconductors by modifying their E_{g} and enhancing their catalytic activity. Non-metallic doping may diminish the rate of recombination of light-generated e⁻-h⁺ pairs by increasing the degradation efficiency of semiconductor materials and causing surface defects. For those reasons, metal-free doping of pure BF is a promising approach for enhancing pure BF's visible light absorption and photocatalytic performance. In addition to the photodegradation ability of pure and modified BF against various pollutants, hydrogen production and storage capacity have also been examined.

Hydrogen is a renewable energy carrier with potential use in the future. It is obtained mostly from water, making it a green fuel; however, producing compact and safe hydrogen production and storage materials is needed to meet safe fuel needs. Developing a hydrogen production and storage material that meets the US Department of Energy's (DOE) 2025 target efficiency of 5.5 wt. % and 40 g/L remains challenging. Furthermore, there are numerous techniques exist for producing and storing hydrogen; however, producing and storing hydrogen as a gas or liquid is expensive, dangerous, and complicated. The electrochemical approach is the most dependable among the main ways for producing and storing hydrogen. It does not need high pressure and can absorb hydrogen ions directly on the working electrode surface. This electrochemical process has piqued great interest because hydrogen is produced when water is split, and direct hydrogen storage occurs at the working electrode, making it an excellent low-cost and pollution-free approach; however, splitting water is a thermodynaically difficult reaction to achieve.

The photodegradation efficiency of current existing pure and modified bismuth ferrite nanoparticles is limited. Their functionality is restricted only to the catalytic activity, which may be useful in the degradation of toxic substances; however, there is a need to develop bismuth ferrite nanoparticles that can exhibit excellent photocatalytic activity in the visible light spectrum and can simultaneously perform other functions, including hydrogen production and storage. Accordingly, an object of the present disclosure is to provide sulfur-incorporated bismuth ferrite nanomaterials having enhanced photodegradation efficiency along with efficient hydrogen generation and storage capacity.

### SUMMARY

In an exemplary embodiment, bismuth ferrite nanoparticles are described. The bismuth ferrite nanoparticles include Bi₂Fe₄O₉ nanoparticles doped with Fe(0) and Bi(0) and sulfur in an amount of 0.5 to 5 percent by weight. At least a portion of bismuth is bonded to at least a portion of the sulfur and at least a portion of iron is bonded to at least a portion of the sulfur. The bismuth ferrite nanoparticles have a longest dimension of 1 to 50 nm.

In some embodiments, the bismuth ferrite nanoparticles comprise bismuth in an oxidation state of Bi(0), Bi(III), and Bi(V).

In some embodiments, the bismuth ferrite nanoparticles iron in an oxidation state of Fe(0), Fe(II), and Fe(III).

In some embodiments, the bismuth ferrite nanoparticles are encapsulated with the sulfur. The bismuth ferrite nanoparticles have a direct band gap (E_{g}) value of 1.9 to 2.3 eV.

In an embodiment, a process of making the bismuth ferrite nanoparticles includes dissolving bismuth and iron in an acid solution to form a first mixture, stirring the first mixture, adding a sulfur salt to the first mixture to form a second mixture, and sonicating the second mixture to form a product. The process further includes centrifuging and washing the product, drying the product at 60 to 100° C. for 10 to 15 hours, and calcinating the product at 500 to 700° C. for 3 to 5 hours to form the bismuth ferrite nanoparticles.

In an embodiment, a method of photocatalytic dye degradation comprises contacting a dye solution with the bismuth ferrite nanoparticles to form a reaction mixture, agitating the reaction mixture in a dark condition for a time sufficient to expose the dye to the bismuth ferrite nanoparticles, and irradiating the reaction mixture with a light for a time sufficient to degrade the dye. The dye solution comprises at least one dye.

In some embodiments, the at least one dye is methylene blue.

In some embodiments, the degradation rate constant is from 0.005 to 0.009 min⁻¹.

In some embodiments, the degradation of the at least one dye is from 80 to 90 percent by weight (wt. %) based on an initial weight of the dye.

In some embodiments, the method of photocatalytic dye degradation comprises agitating the reaction mixture in the dark condition and irradiating the reaction mixture with the light for at least 5 consecutive cycles to degrade the at least one dye.

In some embodiments, the degradation rate of the at least one dye after at least 5 consecutive cycles is 93 to 97 percent of an initial degradation rate.

In some embodiments, holes in electron-hole pairs are the reactive species in a degradation pathway of the at least one dye.

In another embodiment, a method of hydrogen storage comprises connecting a working electrode, a reference electrode, and a counter electrode with a potentiostat, wherein the working electrode is the bismuth ferrite nanoparticles on a graphitic carbon, and contacting the working electrode, the reference electrode, and the counter electrode with an aqueous electrolyte solution, applying a potential, and generating and storing hydrogen at the working electrode.

In some embodiments, the bismuth ferrite nanoparticles have an overpotential of 200 to 270 mV at a current density of 10 mA/cm².

In some embodiments, the bismuth ferrite nanoparticles have a double-layer capacitance (C_{dl}) value of 60 to 145 mF/cm².

In some embodiments, the bismuth ferrite nanoparticles have a surface charge density of 0.02 to 0.06 C/cm².

In some embodiments, the bismuth ferrite nanoparticles have a Tafel slope of 65 to 95 mV/dec.

In some embodiments, the bismuth ferrite nanoparticles have a hydrogen storage capacity of 0.5 to 3.0 wt. % based on a total weight of the bismuth ferrite nanoparticles.

In some embodiments, the bismuth ferrite nanoparticles have a discharge capacity of 190 to 720 mAh/g.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure (including alternative and/or variations thereof) and many of the attendant advantages thereof will be readily obtained as the same becomes better understood by reference to the following detailed description when considered in connection with the accompanying drawings, wherein:

FIG. 1 is a flowchart depicting a method of preparation of bismuth ferrite nanoparticles (BFNPs) using a probe sonication approach, according to certain embodiments;

FIG. 2 is a flowchart depicting a method of photocatalytic dye degradation, according to certain embodiments;

FIG. 3A is a flowchart depicting a method of hydrogen generation and storage, according to certain embodiments;

FIG. 3B shows a reaction scheme depicting the synthesis steps of sulfur-encapsulated bismuth ferrite nanoparticles (SBFNPs) using a probe sonication approach, according to certain embodiments;

FIG. 4 shows X-ray diffractogram (XRD) patterns of pure BFNPs and SBFNPs, according to certain embodiments;

FIG. 5 shows Fourier-transform infrared (FTIR) spectra of pure BFNPs and SBFNPs, according to certain embodiments;

FIG. 6A shows scanning electron microscope (SEM) images of pure BFNPs, according to certain embodiments;

FIG. 6B shows SEM images of SBFNPs, according to certain embodiments;

FIG. 6C shows a transmission electron microscope (TEM) image of pure BFNPs, according to certain embodiments;

FIG. 6D shows a TEM image of SBFNPs, according to certain embodiments;

FIG. 6E shows a high-resolution transmission electron microscope (HR-TEM) image of pure BFNPs, according to certain embodiments;

FIG. 6F shows an HR-TEM image of SBFNPs according to certain embodiments;

FIG. 7 shows energy-dispersive X-ray spectroscopy (EDX) spectra and elemental maps of SBFNPs according to certain embodiments;

FIG. 8A shows X-ray photoelectron spectroscopy (XPS) survey spectrum of SBFNPs, according to certain embodiments;

FIG. 8B shows a high-resolution XPS spectrum of Bi 4f of SBFNPs, according to certain embodiments;

FIG. 8C shows a high-resolution XPS spectrum of Fe 2p of SBFNPs, according to certain embodiments;

FIG. 8D shows a high-resolution XPS spectrum of O 1s of SBFNPs, according to certain embodiments;

FIG. 8E shows a high-resolution XPS spectrum of S 2s of SBFNPs, according to certain embodiments;

FIG. 9A shows diffuse reflectance spectra (DRS) plots of pure BFNPs and SBFNPs, according to certain embodiments;

FIG. 9B shows the Tauc plots of pure BFNPs and SBFNPs, according to certain embodiments;

FIG. 10 shows photoluminescence (PL) emission spectra of pure BFNPs and SBFNPs, according to certain embodiments;

FIG. 11A shows time-dependent absorbance of SBFNPs towards methylene (MB) dye photodegradation, according to certain embodiments;

FIG. 11B shows the photocatalytic MB dye degradation of various catalysts, according to certain embodiments;

FIG. 11C shows pseudo-first-order kinetics for MB dye photodegradation of various catalysts, according to certain embodiments;

FIG. 11D shows stability of SBFNPs against MB dye photodegradation, according to certain embodiments;

FIG. 12A shows active species trapping experiment for the photodegradation of MB dye by SBFNPs under light irradiation, according to certain embodiments;

FIG. 12B shows charge transfer mechanisms for the photodegradation of MB dye by SBFNPs under light irradiation, according to certain embodiments;

FIG. 13A shows linear sweep voltammetry (LSV) polarization curves of pure BFNPs and the SBFNPs, according to certain embodiments;

FIG. 13B shows overpotential (n) histogram of pure BFNPs and SBFNPs, according to certain embodiments;

FIG. 13C shows cyclic voltammetry (CV) curve of pure BFNPs and SBFNPs, according to certain embodiments;

FIG. 13D shows electrochemical double-layer capacitance (C_{dl}) histogram of pure BFNPs and SBFNPs, according to certain embodiments;

FIG. 14 shows CV curves of pure BFNPs and SBFNPs, according to certain embodiments;

FIG. 15 shows surface charge density (QS) histogram of pure BFNPs and SBFNPs, according to certain embodiments;

FIG. 16A shows electrochemical surface area (ECSA) histogram of pure BFNPs and SBFNPs, according to certain embodiments;

FIG. 16B shows active sites histogram of pure BFNPs and SBFNPs, according to certain embodiments;

FIG. 16C shows Tafel curves of pure BFNPs and SBFNPs, according to certain embodiments;

FIG. 16D shows the stability curve of pure BFNPs and SBFNPs, according to certain embodiments;

FIG. 17A shows hydrogen discharge capacities of pure BFNPs and SBFNPs at 1.0 milliamperes (mA), according to certain embodiments;

FIG. 17B shows a histogram plot showing an improvement in hydrogen storage capacity due to sulfur doping, according to certain embodiments; and

FIG. 17C shows the hydrogen discharge capacity of SBFNPs compared to other materials, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “electrode” refers to an electrical conductor that contacts a non-metallic part of a circuit, e.g., a semiconductor, an electrolyte, a vacuum, or air.

As used herein, “working electrode” refers to the electrode in an electrochemical cell/device/sensor on which the electrochemical reaction of interest is occurring.

As used herein, “counter electrode” (also called “auxiliary electrode”) is an electrode used in an electrochemical cell for voltametric analysis or other reactions in which an electric current is expected to flow. A counter electrode is used in an electrochemical cell to complete the circuit and allow charge to flow.

As used herein, the term “electrolyte” is a substance that forms a solution that can conduct electricity when dissolved in a polar solvent. The electrolyte is a medium containing ions that is electrically conductive through the movement of ions and not electrons.

As used herein, the term “Tafel slope” refers to the relationship between the overpotential and the logarithmic current density. The Tafel slope is determined by the Tafel equation, which is an equation in electrochemical kinetics relating the rate of an electrochemical reaction to the overpotential.

As used herein, the term “glassy carbon” refers to a non-graphitizing carbon that combines glassy and ceramic properties with those of graphite. Properties of glassy carbon include high thermal stability, resistance to chemical degradation, high tensile and compressive strengths, and low electrical resistivity.

As used herein, the term “electrochemical cell” refers to a device capable of generating electrical energy from chemical reactions occurring in it or using electrical energy to cause chemical reactions in it. Electrochemical cells are capable of converting chemical energy into electrical energy and/or converting electrical energy into chemical energy.

As used herein, the term “current density” refers to the amount of electric current traveling per unit cross-section area.

As used herein, the term “overpotential” refers to the difference in potential (voltage) between a thermodynamically determined reduction potential of a half-reaction and the potential at which the redox event is experimentally observed. The term is directly associated with a cell's voltage efficiency. In an electrolytic cell, overpotential implies that the cell needs more energy than thermodynamically expected to drive a reaction. The amount of overpotential is specific to each cell design and varies across cells and operational conditions, even for the same reaction. Overpotential is experimentally measured by determining the potential at which a given current density is reached.

As used herein, the term “degradation” refers to the removal of a substance from a system by breaking it down into smaller, easier-to-eliminate by-products.

As used herein, the term “electrochemically active surface area” refers to the surface area of an electrocatalyst having active sites for a given reaction to take place.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “water splitting” refers to the chemical reaction in which water is broken down into oxygen and hydrogen:

2H₂O→2H₂+O₂

The present disclosure is intended to include all hydration states of a given compound or formula, unless otherwise noted or when heating a material.

Unless otherwise noted, the present disclosure is intended to include all isotopes of a given compound or formula.

Aspects of the present disclosure are directed to synthesizing bismuth ferrite nanoparticles and particularly, to synthesizing sulfur-incorporated bismuth ferrite nanoparticles by a probe sonication method. A series of dual Bi⁰/Fe⁰-rich in sulfur-encapsulated bismuth ferrite nanoparticles (SBFNPs) with a sulfur content ranging from 1% to 3% were prepared using a probe sonication approach. The prepared SBFNPs were characterized using various analytical methods. The prepared SBFNPs were tested for their ability to degrade a methylene-blue (MB) solution under visible light illumination at different time intervals. The SBFNPs with a sulfur content of 2% exhibited a maximum photodegradation ability of 84.20% following 120 minutes of light exposure. The MB degradation rate of the SBFNPs (0.00839 min⁻¹) was faster than that of pure BFNPs (0.00308 min⁻¹). The hydrogen storage capacity of the SBFNPs was also evaluated using chronopotentiometry. The SBFNPs exhibited a maximum discharge capacity of 717.35 mA h g⁻¹ and a hydrogen storage capacity of 2.66 wt. % at a 2% sulfur content. The prepared SBFNPs exhibit great potential in visible light photocatalysis and electrochemical hydrogen production and storage capacity.

According to an aspect of the present disclosure sulfur incorporated bismuth ferrite nanoparticles wherein the nanoparticles comprise Bi₂Fe₄O₉ nanoparticles are described. The Bi₂Fe₄O₉ nanoparticles are doped with metallic iron and bismuth. In some embodiments, the Bi₂Fe₄O₉ nanoparticles are doped with iron (Fe) in oxidation states of Fe(0), Fe(II) and Fe(III). In some embodiments, the Bi₂Fe₄O₉ nanoparticles are doped with bismuth (Bi) in oxidation states of Bi(0), Bi(III), and Bi(V). In certain embodiments, the Bi₂Fe₄O₉ nanoparticles are doped with Fe(0) and Bi(0).

In some embodiments, the Bi₂Fe₄O₉ nanoparticles are doped with sulfur, wherein sulfur may be present in an amount of 0.5 to 5% by weight (wt. %). In one embodiment, sulfur may be present in an amount of 0.6 to 4.5 wt. %, preferably 0.7 to 4 wt. %, preferably 0.8 to 3.5 wt. %, more preferably 0.9 to 3.2 wt. %, and yet more preferably about 1 to 3 wt. %. In a specific embodiment, sulfur is present in an amount of 1 to 3 wt. %. In a preferred embodiment, sulfur may be present in an amount of 2 wt. %.

In some embodiments, the bismuth ferrite nanoparticles are encapsulated with sulfur. The bismuth and iron in the nanoparticles may be bonded to sulfur to form the encapsulation. In some embodiments, sulfur-encapsulation includes covering 10 to 100%, preferably 20 to 90%, preferably 30 to 80%, preferably 40 to 70%, preferably 50 to 60%, of an outer surface of the bismuth ferrite nanoparticles. In some embodiments, sulfur-incorporation includes integrating the sulfur into the bismuth ferrite nanoparticles. In some embodiments, the sulfur may displace oxygen atoms in the bismuth ferrite nanoparticles. In some embodiments, the bonding of bismuth and iron to sulfur is arranged in a manner that at least one portion of bismuth is bonded to at least one portion of sulfur and at least one portion of iron is bonded to at least one portion of sulfur. In some embodiments, at least a portion of the sulfur is incorporated into the bismuth ferrite nanoparticles. In some embodiments, at least a portion of the sulfur encapsulates an outer surface of the bismuth ferrite nanoparticles. The encapsulation of bismuth ferrite nanoparticles by sulfur enhances the photocatalytic activity of the nanoparticles.

The nanoparticles may have sizes varying between 1 to 50 nm. In some embodiments, the nanoparticles may have sizes varying between 3 to 48 nm, preferably 5 to 46 nm, preferably 7 to 44 nm, preferably 9 to 42 nm, preferably 11 to 40 nm, preferably 13 to 38 nm, preferably 15 to 36 nm, preferably 17 to 34 nm, preferably 19 to 32 nm, preferably 21 to 30 nm, more preferably 23 to 28 nm, and yet more preferably about 25 to 26 nm.

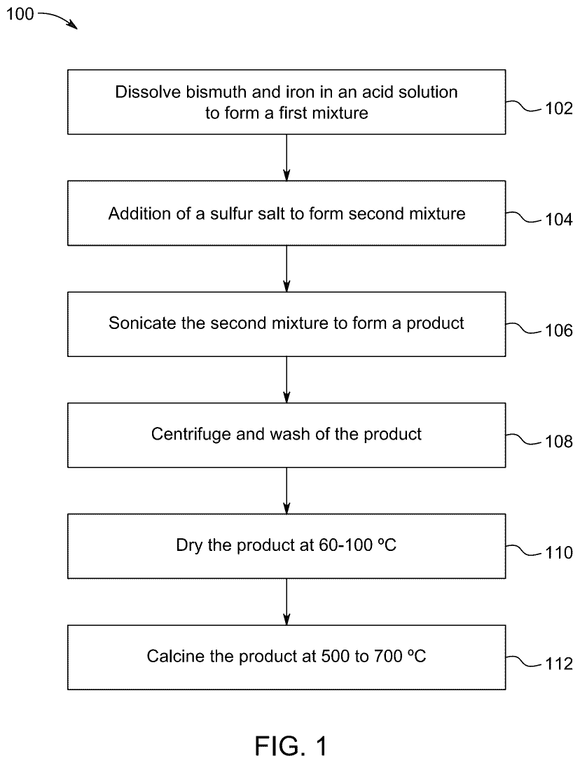

FIG. 1 illustrates a flowchart depicting a method 100 for preparation of bismuth ferrite nanoparticles. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes dissolving bismuth and iron in an acid solution to form a first mixture. In a preferred embodiment, metallic bismuth and metallic iron are dissolved in the acid solution to form the first mixture. The acid solution may be formed by dissolving an acid in a solvent which is preferably water. The acid in the acid solution may be an organic acid or an inorganic acid. In some embodiments, the acid is an inorganic acid. Suitable examples for inorganic acid that can be used herein are hydrochloric acid (HCl), sulfuric acid (H₂SO₄), nitric acid (HNO₃), perchloric acid (HClO₄), boric acid (H₃BO₃), and the like. In a specific embodiment, the metallic bismuth and metallic iron are dissolved in nitric acid (HNO₃) to form the first mixture. A dilute solution of HNO₃ is preferred, wherein a 5 to 15% HNO₃ solution may be used, preferably 6 to 14%, preferably 7 to 13%, more preferably 8 to 12%, and yet more preferably about 9 to 11%. In one embodiment, the HNO₃ solution is a 10% HNO₃ solution. The dissolution process includes mixing the bismuth, iron, and acid solution and stirring the mixture. Stirring may be carried out manually or with the help of a stirrer. Stirring can be done intermittently or continuously. In one embodiment, the stirring is done manually. In another embodiment, stirring is done by a stirrer. Suitable examples of stirrers that may be used include a magnetic stir bar, a stirring rod, an impeller, a shaking platform, and the like. The mixture is stirred for a period of 20 to 40 minutes, preferably 22 to 38 minutes, preferably 24 to 36 minutes, more preferably 26 to 34 minutes, and yet more preferably about 28 to 32 minutes. In certain embodiments, the mixture is stirred for a period of about 30 minutes to obtain a uniform solution.

At step 104, the method 100 includes addition of a sulfur salt to the first mixture to obtain a second mixture. In some embodiments, the sulfur salt is an inorganic sulfur salt. The sulfur salt may be sodium sulfide (Na₂S), sodium hydrosulfide (NaHS), and the like. In certain embodiments, the sulfur salt is sodium sulfide (Na₂S), and the Na₂S is added to the first mixture to form the second mixture.

At step 106, the method 100 includes sonicating the second mixture to form a product. The second mixture is subjected to sonication, preferably probe sonication, which is carried out using a probe sonicator. The probe sonication is carried out for 10 to 20 minutes, preferably 11 to 19 minutes, preferably 12 to 18 minutes, preferably 13 to 17 minutes, more preferably 14 to 16 minutes, and yet more preferably about 15 minutes, to obtain a homogeneous product.

At step 108, the method 100 includes centrifuging and washing the product obtained from sonication. The centrifugation of the product is carried out at 10,000-15,000 revolutions per minute (rpm). In some embodiments, the centrifugation may be carried out at 12,000-14,000 rpm. Centrifugation for a period of 2 to 10 minutes may be sufficient for separating any unreacted material from the product in the mixture. In some embodiments, the centrifuged product is washed one or more times, preferably with an organic solvent, to remove any unreacted material, if still present after centrifugation. In certain embodiments, the product may be washed one or more times with the organic solvent. In specific embodiments, the product may be washed two or three time with ethanol. Washing with the organic solvent is followed by further washing with water. In preferred embodiments, the product is washed with deionized water to remove traces of the organic solvent. In specific embodiments, the product is washed two or three times with water.

At step 110, the method 100 includes drying the product at 60-100° C., preferably 70-90° C., and more preferably about 80° C. The drying is done, at least for a period of 10 to 15 hours. In some embodiments, the drying is done for a period of 11 to 14 hours, preferably for a period of 12 to 13 hours. In preferred embodiments, the drying is done for a period of 12 hours to obtain a sufficiently dry and purified product. The drying can be done by using heating appliances such as ovens, microwaves, autoclaves, hot plates, heating mantles and tapes, oil baths, salt baths, sand baths, air baths, hot-tube furnaces, hot-air guns, and the like.

At step 112, the method 100 includes calcinating the product at 500 to 700° C. to form the bismuth ferrite nanoparticles. The calcination may be carried out by placing the dried product into a furnace, for example, in a ceramic crucible (e.g., an alumina crucible) or other forms of containment, and heating to the specified temperatures. The furnace is preferably equipped with a temperature control system, which may provide temperatures of 500-700° C., preferably 525-675° C., preferably 550-6500° C., more preferably 575-625° C., and yet more preferably about 600° C. The calcination is carried out for a period of 2-5 hours, preferably 3-4 hours, and preferably about 4 hours, to obtain the bismuth ferrite nanoparticles.

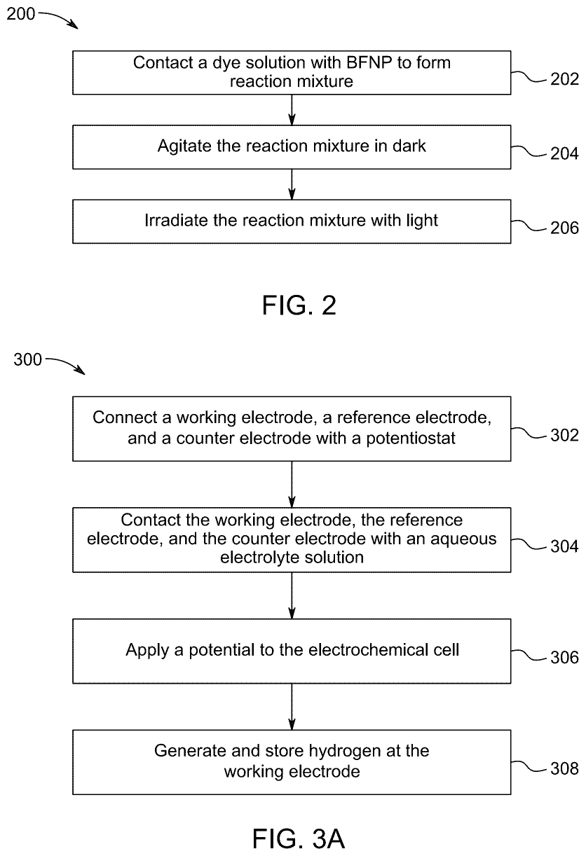

The prepared bismuth ferrite nanoparticles are used to degrade toxic dyes that may be released into the ecosystem along with wastewater, particularly from industries. These nanoparticles show enhanced efficiency in dye degradation in visible light. In some embodiments, a method 200 of photocatalytic degradation of dyes is disclosed. The method 200 is further illustrated by way of a flowchart depicted in FIG. 2. The order in which the method 200 is described is not intended to be construed as a limitation, and any number of the described method steps can be combined in any order to implement the method 200. Additionally, individual steps may be removed or skipped from the method 200 without departing from the spirit and scope of the present disclosure.

At step 202, the method 200 includes contacting a dye solution with bismuth ferrite nanoparticles to form a reaction mixture. The nanoparticles, according to the present invention, can be used for the degradation of dyes, especially non-biodegradable dyes. Non-biodegradable dyes are synthetic dyes that cannot be readily broken down into simpler components. Any synthetic dye, including azo dyes and non-azo dyes, can be degraded by photocatalysis using the nanoparticles of the present disclosure. In some embodiments, the dye solution may comprise one or more dyes. In certain embodiments, the dye solution may comprise a mixture of dyes, including methylene blue (MB), rhodamine B (RB), methyl orange (MO), 4-nitrophenol, and the like. In one embodiment, the dye solution comprises methylene blue.

At step 204, the method 200 includes agitating the reaction mixture to expose the dye to the bismuth ferrite nanoparticles. The agitation process is preferably carried out in the dark to allow the mixture to reach its adsorption and desorption equilibrium. The agitation may be carried out at the rate of 120 to 160 rpm, preferably 130 to 155 rpm, more preferably 140 to 150 rpm, and yet more preferably about 150 rpm. The agitation may be carried out for a period of 20 to 40 minutes, preferably 25 to 35 minutes, and more preferably for about 30 minutes.

At step 206, the method 200 includes irradiating the reaction mixture with a light to degrade the dye in the dye solution. The irradiation is preferably done in visible light. In some embodiments, the reaction mixture is irradiated with visible light for a period of 80 to 120 minutes, preferably 85 to 120 minutes, preferably 90 to 120 minutes, preferably 95 to 120 minutes, preferably 100 to 120 minutes, preferably 105 to 120 minutes, preferably 110 to 120 minutes, preferably 115 to 120 minutes. In a preferred embodiment, the reaction mixture is irradiated with visible light for a period of 120 minutes for the photocatalytic degradation of the dye.

In some embodiments, the reaction mixture is agitated in the dark and irradiated with visible light alternatively to achieve complete degradation of the dye. In one embodiment, the reaction mixture is agitated in the dark and irradiated with visible light for at least 2 to 5 consecutive cycles. A cycle includes agitating the reaction mixture in the dark followed by irradiating the reaction mixture with visible light. In another embodiment, the reaction mixture is agitated in the dark and irradiated with visible light for at least 3 to 5 consecutive cycles, preferably at least 4 to 5 consecutive cycles to achieve the degradation of the dye. In a preferred embodiment, the reaction mixture is agitated in the dark and irradiated with visible light for at least 5 consecutive cycles to achieve the degradation of the dye.

In some embodiments, the degradation of dye after at least 5 consecutive cycles is 93 to 97%, preferably 94 to 96%, and more preferably about 95% of an initial degradation rate. In certain embodiments, the degradation of dye after at least 5 consecutive cycles is 94%, preferably 95%, and more preferably 96% of an initial degradation rate.

The nanoparticles of the present invention have good photocatalytic efficiency, which is exhibited by a reduction in the weight of the dye in the reaction mixture. In some embodiments, the weight of the dye in the reaction mixture, after 2 to 5 consecutive cycles, reduces by 80 to 90%, preferably 81 to 89%, preferably 82 to 88%, preferably 83 to 87%, more preferably 84 to 86%, and yet more preferably about 85% based on the initial weight of the dye.

The degradation of dyes occurs in the presence of reactive species produced in the reaction mixture during the degradation process. A primary reactive species includes holes (h⁺), which either act alone or in combination with hydroxyl radicals (·OH) to degrade the dyes into environment friendly products. The catalytic activity of the nanoparticles can be construed from the high value of degradation rate constants which vary between 0.005 to 0.009 min⁻¹ for various dyes. In certain embodiments, the degradation rate constant of the nanoparticles varies between 0.006 to 0.009 min⁻¹, preferably between 0.007 to 0.009 min-1, and more preferably between 0.008 to 0.009 min⁻¹ for various dyes. In a preferred embodiment, the degradation rate constant of the nanoparticles for methylene blue is around 0.008 min⁻¹.

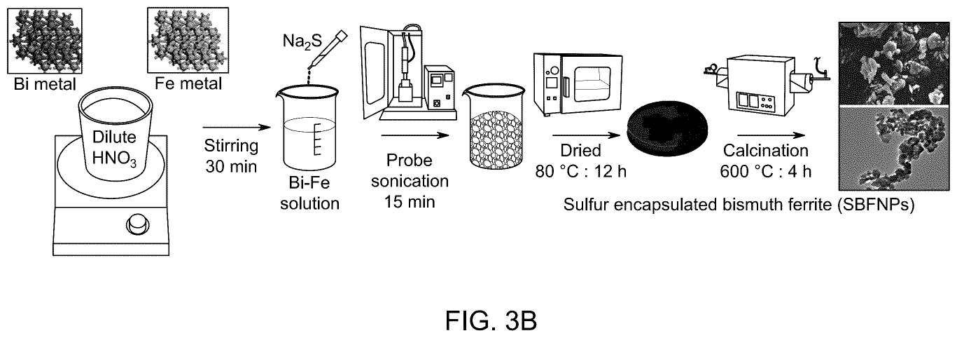

The bismuth ferrite nanoparticles can produce hydrogen and simultaneously enable the storage of hydrogen that can be used later in various applications. An electrochemical cell with a three-electrode setup containing a working electrode, a counter electrode, and a reference electrode is used to determine the hydrogen generation and storage potential of the nanoparticles. A method 300 for the generation and storage of hydrogen using the electrochemical cell is further disclosed, which is illustrated by a flowchart shown in FIG. 3A. The order in which the method 300 is described is not intended to be construed as a limitation, and any number of the described method steps can be combined in any order to implement the method 300. Additionally, individual steps may be removed or skipped from the method 300 without departing from the spirit and scope of the 1 present disclosure.

At step 302, the method 300 includes connecting a working electrode, a reference electrode, and a counter electrode with a potentiostat. In an embodiment, the working electrode comprises the bismuth ferrite nanoparticles according to the present disclosure. The nanoparticles are coated on a substrate, preferably carbon, to prepare the working electrode. In a specific embodiment, the nanoparticles are coated on glassy carbon that acts as the working electrode.

The material of the counter electrode should be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or might lead to undesirable contamination of either electrode. The counter electrode may contain an electrically conductive material such as platinum, platinum-iridium alloy, iridium, titanium, titanium alloy, stainless steel, gold, cobalt alloy, and the like, and/or some other electrically conductive material having an electrical resistivity of about 10⁻⁶ Ω·m, to 10⁻⁸ Ω·m at a temperature of 20-25° C. In some embodiments, the counter electrode is made from at least one material selected from the group consisting of platinum, gold, and carbon. In one embodiment, the counter electrode is made of carbon. In a preferred embodiment, the counter electrode is made of graphite carbon. In one embodiment, the counter electrode may be in form of a wire, a rod, a cylinder, a tube, a woven mesh, a perforated sheet, a brush, and the like. In certain embodiments, the counter electrode is in the form of a rod.

A reference electrode may enable a potentiostat to deliver a stable voltage to the working electrode and/or the counter electrode. The reference electrode may be RHE, a standard hydrogen electrode (SHE), a normal hydrogen electrode (NHE), a saturated calomel electrode (SCE), a Cu—Cu (II) sulfate electrode (CSE), a silver/silver chloride electrode (Ag/AgCl), a pH-electrode, a palladium-hydrogen electrode, a dynamic hydrogen electrode (DHE), a mercury-mercurous sulfate electrode, and the like. In a preferred embodiment, the reference electrode is Ag/AgCl.

At step 304, the method 300 includes contacting the working electrode, the reference electrode, and the counter electrode with an aqueous electrolyte solution. In some embodiments, the aqueous solution is water and an inorganic base. The water may be tap water, distilled water, deionized water, reverse osmosis water, seawater, and the like. Preferably, the water is seawater. In some embodiments, the water is alkaline water. The alkaline water has a pH in the range of 7-13, preferably 8-12, preferably 9-11.

The inorganic base in the aqueous solution may be selected from a group consisting of an alkaline earth metal hydroxide and an alkali metal hydroxide. The base may be selected from the group consisting of an alkaline earth metal hydroxide, such as beryllium hydroxide (Be(OH)₂), magnesium hydroxide (Mg(OH)₂), strontium hydroxide (Sr(OH)₂), and calcium hydroxide (Ca(OH)₂), and an alkali metal hydroxide, such as lithium hydroxide (LiOH), sodium hydroxide (NaOH), potassium hydroxide (KOH) and rubidium hydroxide (RbOH), and cesium hydroxide (CsOH). In a preferred embodiment, the base is potassium hydroxide.

At step 306, the method 300 includes applying a potential to the electrochemical cell such that the aqueous solution is reduced, resulting in the formation of the hydrogen gas. The bismuth ferrite nanoparticles have an overpotential of 200-270 mV, preferably 205-265 mV, preferably 210-260 mV, preferably 215-255 mV, preferably 220-250 mV, preferably 225-245 mV, preferably 230-240 mV at a current density of 10 mA/cm². As used herein, the term “overpotential” is referred to as the difference between the equilibrium potential for a given reaction (also called the thermodynamic potential) and the potential at which a catalyst operates at a specific current under specific conditions.

At step 308, the method 300 includes generating and storing hydrogen at the working electrode. The hydrogen produced by applying a potential to the electrochemical cell is transferred to the working electrode, where it is stored. In some embodiments, the hydrogen produced at the working electrode may be stored at the working electrode and/or a secondary storage system. The hydrogen storage capacity of the nanoparticles is determined by their hydrogen discharge capacity. In certain embodiments, the hydrogen discharge capacity of the bismuth ferrite nanoparticles is between 190 to 720 mAh/g. In other embodiments, the hydrogen discharge capacity of the bismuth ferrite nanoparticles is between 240 to 720 mAh/g, preferably 290 to 720 mAh/g, preferably 340 to 720 mAh/g, preferably 390 to 720 mAh/g, preferably 440 to 720 mAh/g, preferably 490 to 720 mAh/g, preferably 540 to 720 mAh/g, preferably 590 to 720 mAh/g, preferably 640 to 720 mAh/g, preferably 690 to 720 mAh/g.

In some embodiments, the bismuth ferrite nanoparticles have a hydrogen storage capacity of 0.5 to 3.0 wt. % based on the total weight of the bismuth ferrite nanoparticles. In other embodiments, the bismuth ferrite nanoparticles have a hydrogen storage capacity of 1 to 3.0 wt %, preferably 1.5 to 3.0 wt %, preferably 2 to 3.0 wt %, preferably 2.5 to 3.0 wt %, based on total weight of the bismuth ferrite nanoparticles.

The electrochemically active surface area (ECSA) of the nanoparticles is determined from their double layer capacitance value which lies between 60 to 145 mF/cm². In some embodiments, the double layer capacitance value of the nanoparticles range from 65 to 145 mF/cm², preferably 70 to 145 mF/cm², preferably 75 to 145 mF/cm², preferably 80 to 145 mF/cm², preferably 85 to 145 mF/cm², preferably 90 to 145 mF/cm², preferably 95 to 145 mF/cm², preferably 100 to 145 mF/cm², preferably 105 to 145 mF/cm², preferably 110 to 145 mF/cm², preferably 115 to 145 mF/cm², preferably 120 to 145 mF/cm², preferably 125 to 145 mF/cm², preferably 130 to 145 mF/cm², preferably 135 to 145 mF/cm², preferably 140 to 145 mF/cm². A higher value of double-layer capacitance for the bismuth ferrite nanoparticles is indicative of a surface area having a higher number of active sites for photocatalysis.

In some embodiments, the bismuth ferrite nanoparticles show a surface charge density (QS) of 0.02 to 0.06 C/cm². In other embodiments, the nanoparticles show a surface charge density of 0.03 to 0.06 C/cm², preferably 0.04 to 0.06 C/cm², preferably 0.05 to 0.06 C/cm². Further, the nanoparticles' Tafel slope values range between 65 and 95 mV/dec, preferably 70 and 90 mV/dec, preferably 75 and 85 mV/dec. The bismuth ferrite nanoparticles have a direct band gap energy (E_{g}) value of 1.9 to 2.3 eV, preferably 2.0 to 2.2 eV.

The indicated values of various parameters are suggestive of the enhanced photocatalytic performance of sulfur-encapsulated bismuth ferrite nanoparticles.

### EXAMPLES

The following examples demonstrate sulfur-incorporated bismuth ferrite nanoparticles for photocatalytic dye degradation and hydrogen generation and storage. The examples are provided solely for illustration and are not to be construed as limitations of the present disclosure, as many variations thereof are possible without departing from the spirit and scope of the present disclosure.

### Example 1: Materials

Pure metals of bismuth (Bi), iron (Fe), and sodium sulfide (Na₂S) were procured from Alfa Aesar. Analytical grade nitric acid (HNO₃), Nafion, potassium hydroxide (KOH), and ethanol (C₂H₅OH) were purchased from Sigma Aldrich. All chemicals were employed precisely as specified, and the solvent was deionized water (DIW).

### Example 2: Preparations of SBFNPs Framework

The probe sonication approach was used to synthesize a new series set of dual Bi⁰/Fe⁰-rich in sulfur-encapsulated BFNPs (SBFNPs), as shown in FIG. 3B. The samples were coded as SiBFNPs, S₂BFNPs, and S₃BFNPs based on their sulfur content of 1.0, 2.0, and 3.0%, respectively. In brief, the precursor solutions were prepared at room temperature with constant stirring using stoichiometric quantities of metallic Bi and Fe in dilute HNO₃ (10%) solution. In various ratios, Na₂S was employed as a sulfur(S) encapsulate. During precipitation, the solution was probe-sonicated for 15 minutes to form a homogenous solution. The final product was centrifuged and washed with C₂H₅OH and DIW. Finally, the residue was oven-dried for 12 hours at 80° C. before being calcined for 4 hours at 600° C.

### Example 3: Characterizations

An X-ray diffractometer (XRD, Rigaku with Cu-Kα line) at 20=10-80° was used to analyze the crystallinity of the obtained SBFNPs. Scanning electron microscopy (SEM, JEOL) and transmission electron microscopy (TEM, Tecnai G2 30ST) were used to examine the microstructures and morphologies of the SBFNPs. The elements identification and mapping were carried out using an energy dispersive X-ray (EDX) spectrometer connected to the SEM. Fourier-transmission infrared spectra (FTIR, PerkinElmer Spectrometer) were used to record the chemical bonding in the SBFNPs. X-ray photoelectron spectroscopy (XPS, PHI 5000 Versa Probe II spectrophotometer with Al-Kα line, Physical Electronics Inc., USA) was used to record the XPS spectra of the SBFNPs. The optical absorption spectra of the SBFNPs were recorded using UV-Vis diffuse reflectance spectroscopy (DRS, Jasco V-650 spectrophotometer). The photoluminescence (PL) emission spectra of the SBFNPs were obtained using a JASCO FP-8500 and an Xe-lamp as an excitation source at 380 nm.

### Example 4: Measurement of Photocatalytic Activity

The photocatalytic efficiency of the prepared SBFNPs against MB dye degradation was evaluated using visible light irradiation (Xe lamp of 250 W). In brief, the desired amount of the SBFNPs (acting as a catalyst) was added to a 50 mL solution of 10 ppm MB dye. First, the resultant mixture (under dark conditions) was constantly agitated at 150 rpm for 30 minutes before exposure to light to reach adsorption/desorption equilibrium. The suspension was then exposed to visible light. Throughout the test, 2 mL of the solution was sampled at regular intervals, and the MB dye concentration was calculated using UV-Vis absorbance measurements. The degradation efficiency and pseudo-first-order kinetic rate constant were calculated [M. J. S. Mohamed, S. Shenoy, D. K. Bhat, Novel NRGO-CoWO4-Fe2O3 nanocomposite as an efficient catalyst for dye degradation and reduction of 4-nitrophenol, Mater Chem Phys. 208 (2018) 112-122, which is incorporated herein by reference in its entirety] using equations 1 and 2.

Dye degradation efficiency (%)=(C₀−C/C₀)×100 (1)

First-order rate constant (kt)=ln(C₀/C) (2)

Where C₀ and C are the dye concentration (mg/L) before and after exposure to light at time t, respectively, and k is the first-order reaction rate constant.

The recyclability and stability of the best performing catalysts were performed five times to photodegrade MB under similar circumstances. The separated photocatalyst was collected after each experiment, washed with DI water, dried, and reused for the reusability test.

Furthermore, active species trapping experiments were performed by a similar photocatalytic procedure with the addition of scavengers, such as isopropyl alcohol (IPA), 1,4-benzoquinone (BQ), and ethylenediamine tetraacetic acid (EDTA), to trap hydroxyl-radicals (·OH), superoxide-radicals (·O₂⁻), and holes (h⁺), respectively.

### Example 5: Measurement of Electrochemical Analysis

The hydrogen production and storage capability of the SBFNPs was used to investigate a three electrode set-up (AutoLab electrochemical workstation). The SBFNPs, Ag/AgCl, and graphite rods serve as the working electrode, reference electrode, and counter electrode, respectively. An aqueous solution of 1.0 M KOH serves as the electrolyte. Glassy carbon (GC) was employed as a substrate for the SBFNPs electrode to make an electrode of the SBFNPs. The SBFNPs were homogeneously dispersed in Nafion and ethanol for 20 minutes. Then, GC (3.0 mm diameter) was coated with the SBFNPs in Nafion (catalyst loading of 0.285 mg/cm²) and dried at 60° C. for 2 hours.

LSV (linear sweep voltammetry) with a scan rate of 5 mV/s in 1.0 M KOH solution was used to test the hydrogen production performance of the SBFNP electrodes. The measured voltage was fitted to the RHE (reversible hydrogen electrode) using the relation (E_{RHE}=E⁰_{applied}+0.0591×pH+E_{Ag/AgCl}). The Tafel-slopes were calculated using the equation, η=a+b log (j). The ECSA (electrochemically active surface area) of the SBFNPs electrodes was calculated by measuring the CV (cyclic voltammetry) in a non-faradic region (i.e., 0.1 to 0.2 V vs. RHE) at different scan rates (20-100 mV/s). The difference in current density variation (Δj=ja−jc) at an applied potential of 0.15 V vs. RHE was plotted against the scan rate to estimate the C_{dl} (electrochemical double layer capacitance), which was then used to calculate the ECSA [M. J. S. Mohamed, M. A. Gondal, M. Hassan, A. Z. Khan, A. M. Surrati, M. A. Almessiere, Exceptional co-catalysts free SrTiO3 perovskite coupled CdSe nanohybrid catalyst by green pulsed laser ablation for electrochemical hydrogen evolution reaction, Chem Eng J Adv. 11 (2022) 100344, which is incorporated herein by reference in its entirety]. The relation evaluated the ECSA of the SBFNPs electrodes: ECSA=C_{dl}/Cₛ, where Cₛ is the specific capacitance, and a value of 0.035 mF/cm² is used in this study as a specific capacitance [M. J. Sadiq Mohamed, S. Caliskan, M. A. Gondal, M. A. Almessiere, A. Baykal, Y. Slimani, K. A. Elsayed, M. Hassan, I. A. Auwal, A. Z. Khan, Se-doped magnetic Co—Ni spinel ferrite nanoparticles as electrochemical catalysts for hydrogen evolution, ACS Appl Nano Mater. 6 (2023) 7330-7341, which is incorporated herein by reference in its entirety]. The surface active sites (N) of the SBFNP electrodes were evaluated by measuring the CV at 60 mV/s in 1.0 M KOH electrolyte solution. The integrated charge of each SBFNP electrode was divided by two, assuming a one-electron redox process to obtain QS (surface charge density). N=QS/F was used to calculate the value of N [D. Fu, B. Fabre, G. Loget, C. Mériadec, S. A. Girard, E. Cadot, N. L. Laronze, J. Marrot, Q. de Ponfilly, Polyoxothiometalate-derivatized silicon photocathodes for sunlight-driven hydrogen evolution reaction, ACS Omega. 3 (2018) 13837-13849, which is incorporated herein by reference in its entirety]. Furthermore, the cyclic stability of the SBFNP electrodes was evaluated by repeating the CV for 1000 cycles followed by LSV.

The hydrogen storage capacity of the SBFNP electrodes was studied using the charge and discharge cycles via a CP (chronopotentiometry) approach. The potential difference between the working electrode and the reference electrode was measured, wherein the working and counter electrodes were maintained at a fixed current. The electrolyte was dissociated around the working electrode (which served as the cathode), and hydrogen from the solution was absorbed by the SBFNPs during the charging. Under alkaline conditions, the discharge process went in a reverse way, and the hydrogen released from the SBFNPs mixes with the hydroxyl ion to produce water in the solution, while one electron is released. The hydrogen storage capacity of the material was determined by its discharge capacity, which was measured using equation 3.

discharge capacity (mAhg⁻¹)=[current (mA)]×[time (h)/weight of the sample (g)] (3)

### Structural and Morphological Properties

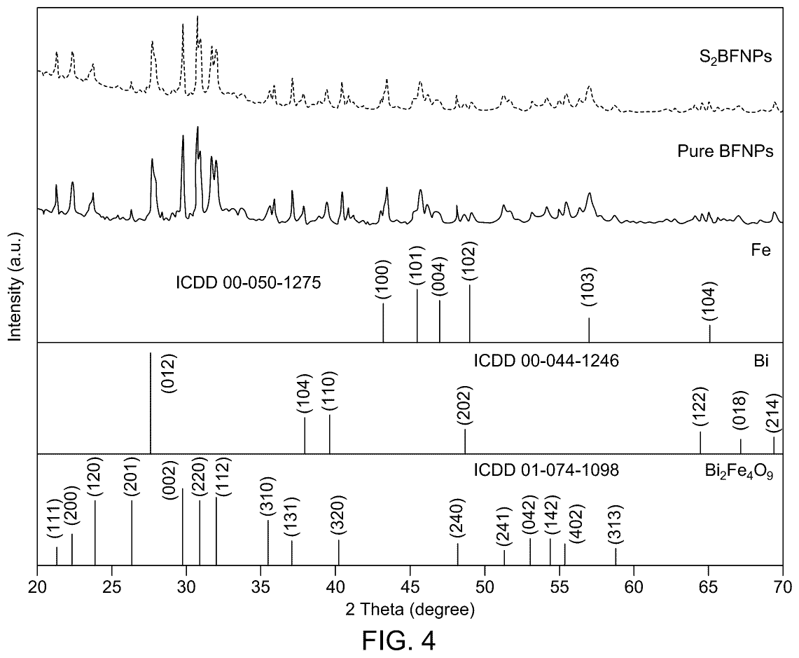

XRD patterns of both pure BFNPs and S₂BFNPs framework are shown in FIG. 4. The diffraction peaks of pure BFNPs effectively identify the different phases found in this study. These phases include orthorhombic Bi₂Fe₄O₉ (ICDD #01-074-1098), as well as the appearance of certain Bi and Fe metallic diffraction peaks in the distinct phases of rhombohedral Bi (ICDD #00-044-1246), and hexagonal Fe (ICDD #00-050-1275), respectively. The absence of additional peaks clearly indicates a successful synthesis of pure BFNPs containing both Bi and Fe-rich (Bi⁰/Fe⁰-rich) crystalline phases. The XRD patterns of pure BFNPs and S₂BFNPs framework were found to be identical, indicating that sulfur-encapsulation did not affect the unique lattice structure in the given initial circumstances.

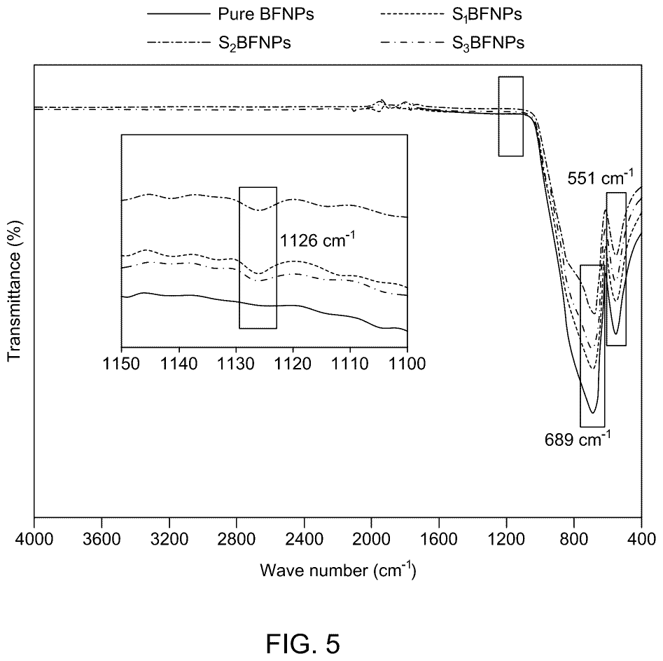

The FTIR spectra of pure BFNPs and SBFNPs framework are shown in FIG. 5. The absorption bands at 551 cm⁻¹ and 689 cm⁻¹ correspond to the functional chemical bonds in pure BFNPs. The band at 551 cm⁻¹ corresponds to the O—Fe—O bending-vibration in the FeO₆ group. The band at 689 cm⁻¹ corresponds to the vibration modes of BiO₆ octahedral units. In the SBFNPs, the peak at 1126 cm⁻¹ is represented by the stretching-vibration of the metal-S bond. These findings indicate that sulfur atoms have been incorporated into the BFNPs lattice, confirming the successful sulfur-encapsulation of the SBFNPs sample. Furthermore, FTIR analysis showed that no metal-S bonds were observed in pure BFNPs samples.

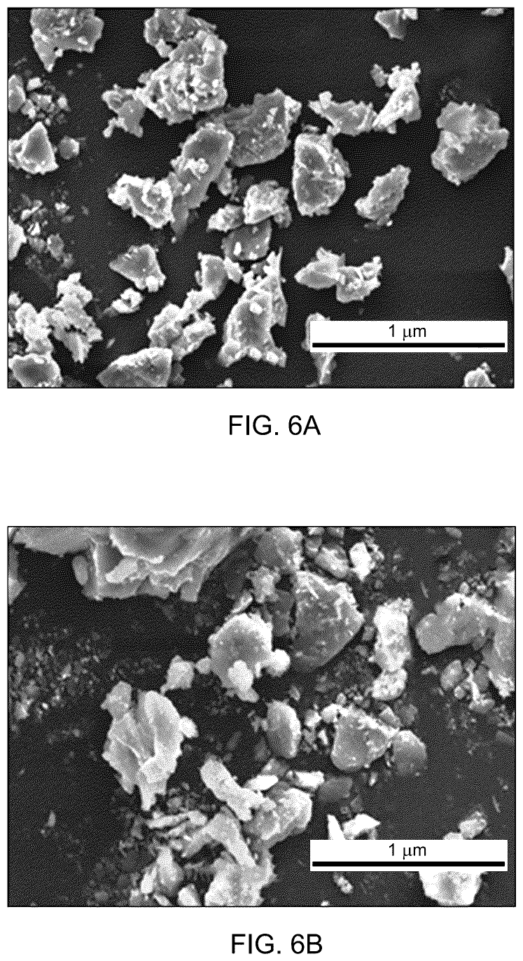

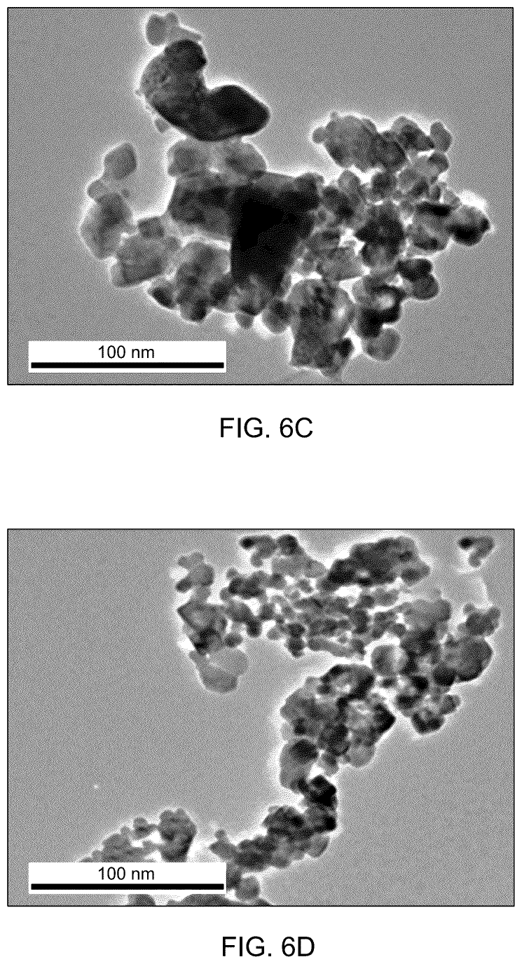

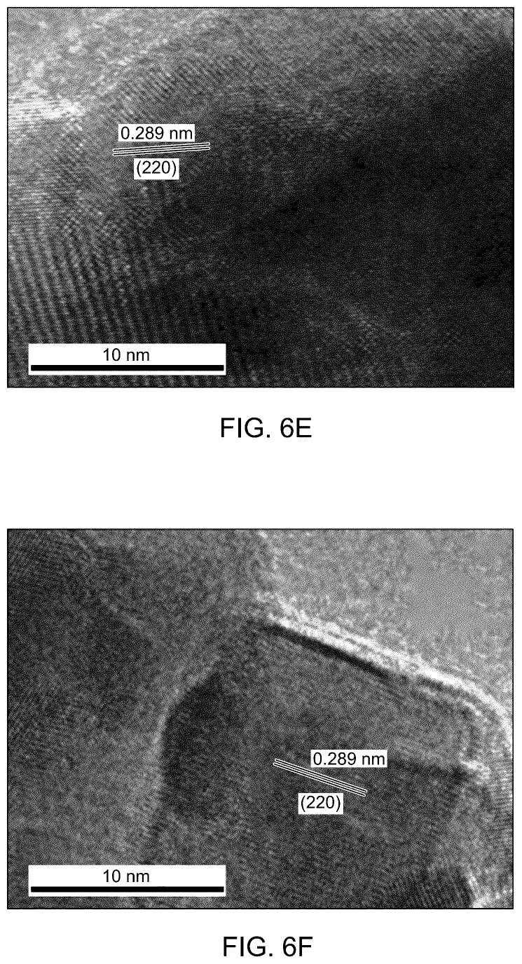

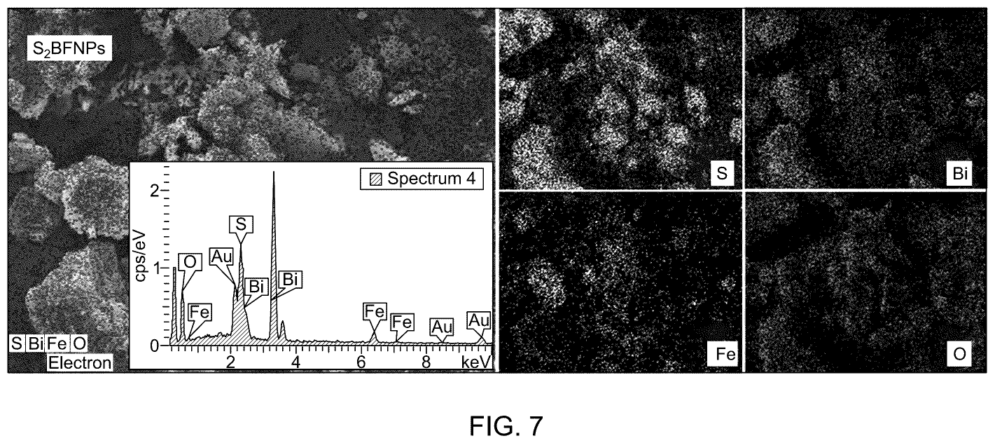

FIG. 6 shows the SEM micrographs of pure BFNPs and S₂BFNPs that indicate the formation of irregular forms (FIG. 6A & FIG. 6B). The appearance of irregular forms in TEM images of pure BFNPs and S₂BFNPs (FIG. 6C & FIG. 6D) was consistent with the SEM findings. HR-TEM micrographs of pure BFNPs and S₂BFNPs with lattice fringes and d-spacing are shown in FIG. 6E & FIG. 6F. The lattice fringes (0.289 nm) matched the phases in pure BFNPs and S₂BFNPs, lending credence to the XRD findings. The d-spacing (220) of pure BFNPs and S₂BFNPs corresponded to their orthorhombic phases. FIG. 7 depicts the EDX spectra and elemental maps of the S₂BFNPs, which demonstrate the presence of trace elements of bismuth (Bi), oxygen (O), iron (Fe), and sulfur(S).

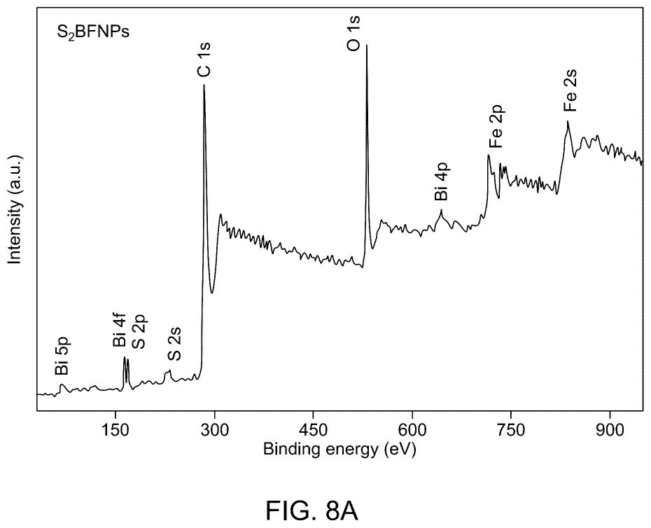

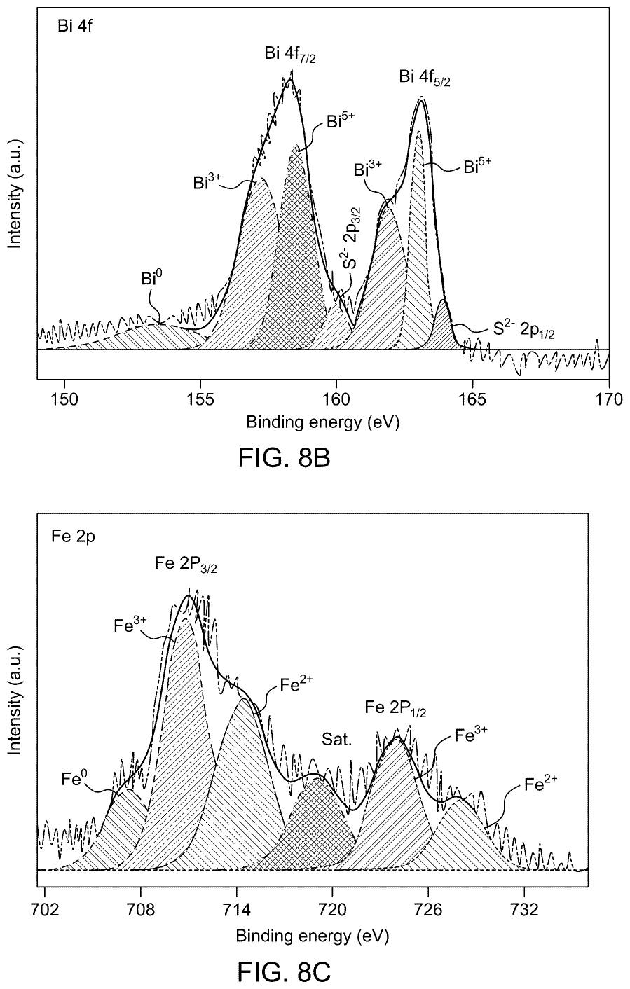

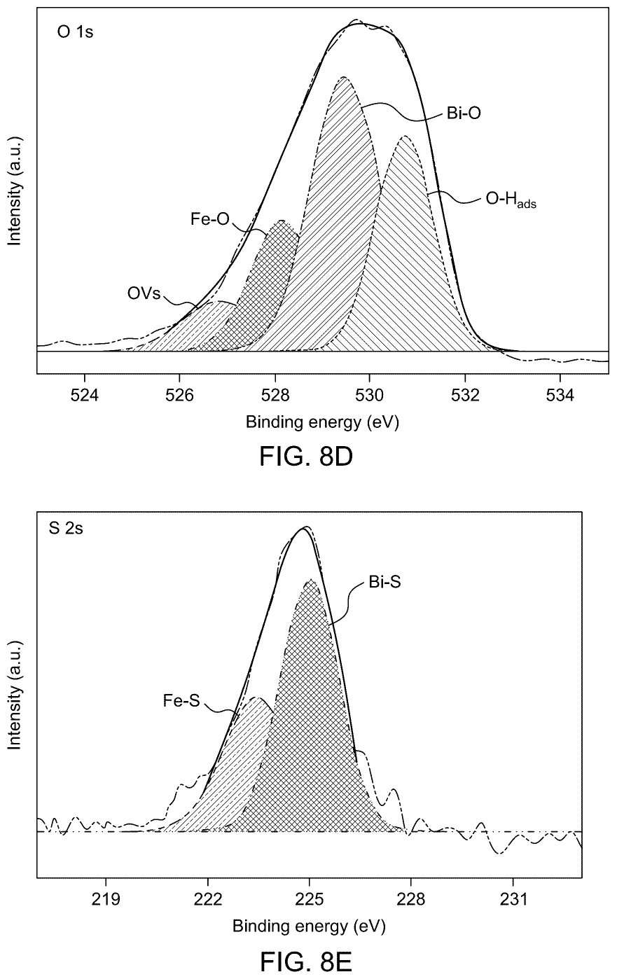

The chemical status of elements and surface defects were investigated using XPS analysis on the S₂BFNPs. The XPS binding energies were adjusted for specimen charging by referencing the C 1s line to 284.6 eV. FIG. 8A of the XPS survey spectrum shows that the S₂BFNPs framework comprises Bi, Fe, O, and S. FIG. 8B shows the high-resolution XPS spectrum of Bi 4f with two peaks with binding energies of 158.2 eV and 163.2 eV, corresponding to the Bi 4f_{7/2} and Bi 4f_{5/2} states, respectively. The Bi—O—Fe bonding arrangement is responsible for the appearance of two distinct peaks in mullite Bi₂Fe₄O₉ [S. K. Rao, S. M. Kamath, E. M. Abhinav, B. Renganathan, K. Jeyadheepan, C. Gopalakrishnan, Unraveling the potential of Gd doping on mullite Bi₂Fe₄O₉ for fiber optic ethanol gas detection at room temperature, Mater Chem Phys. 278 (2022) 125646, which is incorporated herein by reference in its entirety]. Numerous oxidation states of Bi were observed in the S₂BFNPs, including Bi⁰ (153.5 eV), Bi³⁺ (157.2 eV and 161.9 eV), and Bi⁵⁺ (158.5 eV and 162.9 eV), respectively. Furthermore, the appearance of two additional peaks at 160.0 eV and 163.9 eV are ascribed to the S 2p signal generated by residual sulfur on the surface of the S₂BFNPs. Further, the S₂BFNPs have an orthorhombic structure with the co-existence of octahedra FeO₆ and tetrahedra FeO₄. FIG. 8C shows two peaks at around 710.9 eV and 723.9 eV, corresponding to the binding energies of Fe 2p_{3/2} and Fe 2p_{1/2} states, respectively. Several Fe oxidation states were observed in the S₂BFNPs, including Fe⁰ (707.2 eV), Fe2+ (710.8 eV and 723.9 eV), and Fe³⁺ (714.4 eV and 728.0 eV). FIG. 8D depicts the deconvolution of the O 1s peak into four Gaussian curves at around 526.9 eV, 528.2 eV, 529.5 eV, and 530.7 eV, which correspond to oxygen vacancy defects, Fe—O, Bi—O, and absorbed water (O—H_{ads}) molecules on the surface of the S₂BFNPs, respectively. The peaks observed in the S 2s spectra (FIG. 8E) at 223.4 eV and 224.98 eV are ascribed to the 2s orbitals of S in the S₂BFNPs, while these peaks can also be attributed to Fe—S and Bi—S bonds, which have formed owing to the formation of formal metal-sulfur bonds. This finding supports that the active S is incorporated in and ecapsulates the S₂BFNPs. Based on the data, it can be inferred that the presence of sulfur-encapsulated BFNPs, which is rich in both Bi⁰/Fe⁰, leads to the improvement of surface catalytic activity.

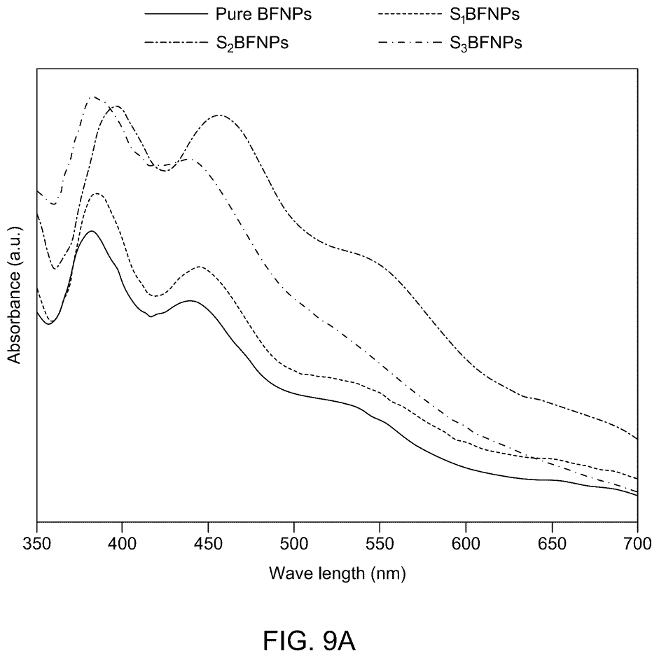

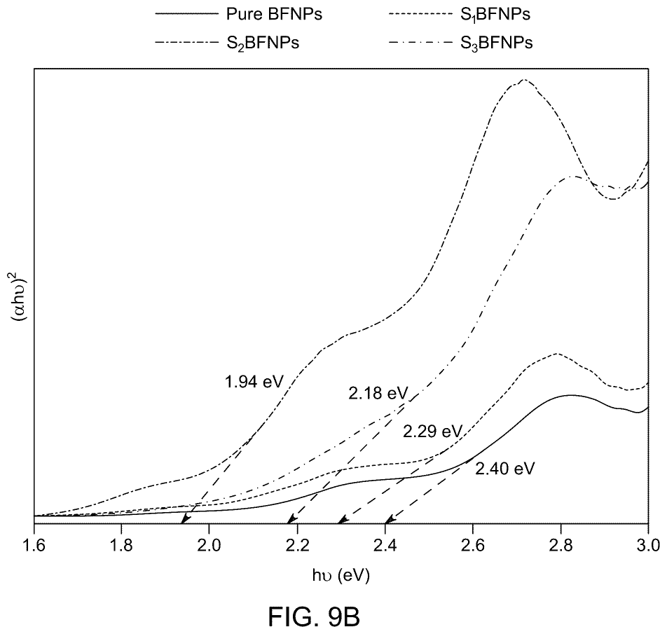

DRS and E_{g} plots of pure BFNPs and SBFNPs are shown in FIGS. 9A-9B. The recorded optical absorption spectrum of the SBFNPs demonstrate an improvement in the visible absorbance over pure BFNPs (FIG. 9A). The absorption edge data was used to generate the Tauc plot, which was used to calculate the optical E_{g} of the prepared SBFNPs. The E_{g} was evaluated using equation 4:

(αhν)²=Δ(E_{g}−hν)η (4)

where α, hν, A, and n are the absorption coefficient, incident photonenergy, scaling constant, and semiconductor material dependent exponent (n can take values ½ or 2 depending on allowed direct and indirect electronic transitions across the forbidden energy gap), respectively. The direct E_{g} of the SBFNPs was calculated by linearly extrapolating the curve between hν and (αhν)² onto the abscissa. FIG. 9B shows the Tauc plots of pure BFNPs and SBFNPs. The obtained direct E_{g} of pure BFNPs, S₁BFNPs, S₂BFNPs, and S₃BFNPs are 2.40 eV, 2.29 eV, 1.94 eV, and 2.18 eV, respectively. Furthermore, the values of E_{g} were reduced when increasing the sulfur content up to 2.0%, and increased again with an increase in sulfur content from 2.0 to 3.0%.

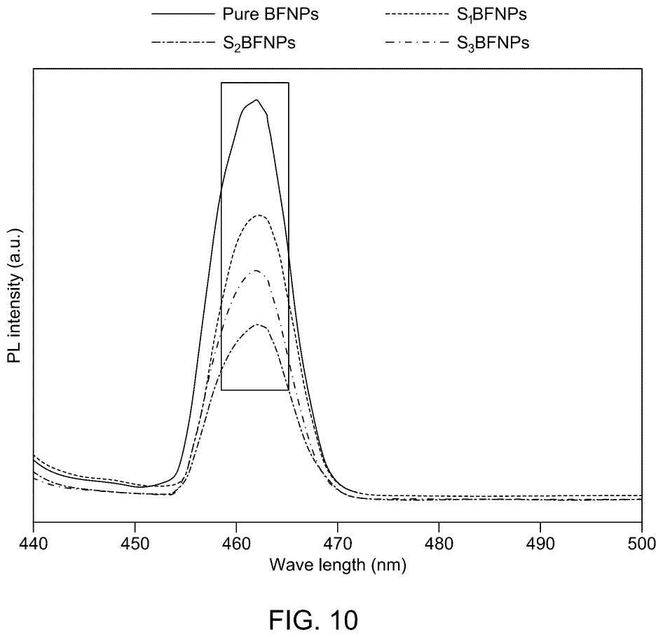

FIG. 10 shows the PL spectra of pure BFNPs and SBFNPs at an excitation wavelength of 380 nm. All the nanoparticles show a prominent emission peak at 462 nm, wherein the peak intensity was proportional to the recombination time of photogenerated carriers (e⁻-h⁺ pairs). Furthermore, with the increase of sulfur contents, the PL peak was appreciably reduced, indicating the lowering of the carriers recombination rate. The S₂BFNPs had the lowest PL intensity, indicating that the carriers recombination rate was improved over pure BFNPs, which is desirable for enhanced photocatalytic and photoelectrochemical processes. Such PL emission features are beneficial for the electronic interactions and enhanced charge carrier separation at the SBFNPs framework interface.

### Photocatalytic Activity Against MB Dye

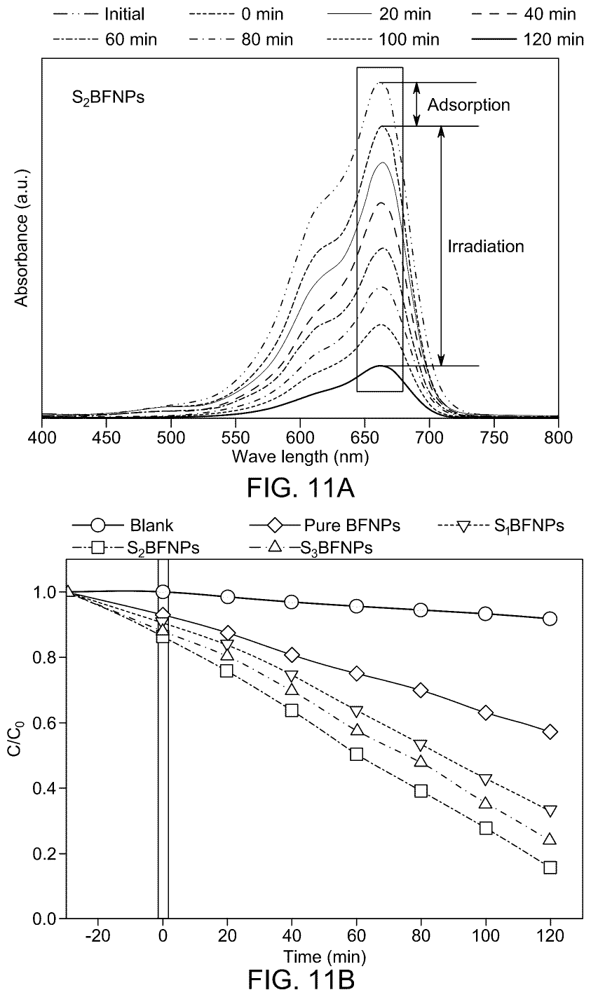

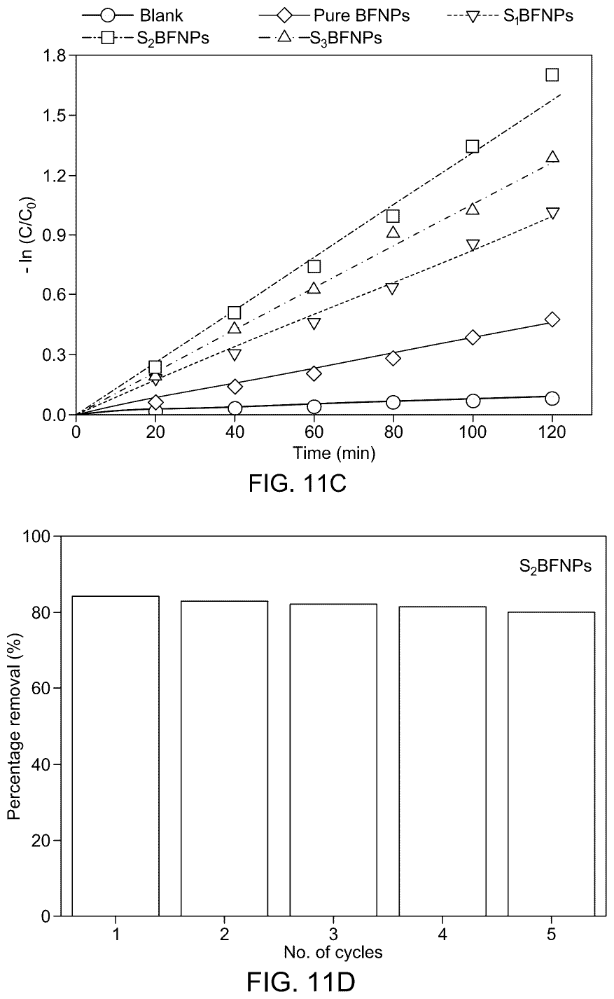

The MB dye solution was used as a generic organic pollutant to evaluate the photocatalytic degradation capability of the prepared pure BFNPs and SBFNPs. The solution containing MB dye and catalysts (prepared SBFNPs) was exposed to visible light with constant shaking (in the dark) for about 30 minutes to achieve an adsorption-desorption equilibrium. FIG. 11A displays the time-dependent photocatalytic absorption of the S₂BFNPs. As a result, the proportion of dye degradation increases over time with the decreased absorption under light irradiation. These findings show that increasing the weight fraction of sulfur increased the photocatalytic efficiency of the SBFNPs (FIG. 11B). The blank test was performed with an MB solution that did not contain a catalyst. The concentration of MB decreased insignificantly after 120 minutes, indicating that photodegradation occurred exclusively in the presence of the photocatalyst. The results also showed that S is a suitable carrier for BF that can enhance its visible light catalytic efficiency, hence accelerating the decay of MB dye. The photocatalytic efficiency of the S₂BFNPs was highest (84.20%) when the light exposure time was 120 minutes. The SBFNPs were covered at increasing sulfur concentrations and incident light adsorption was poor, thus causing a decrease in the catalytic efficiency. It was affirmed that the synergistic effect of dual Bi⁰/Fe⁰-rich, S, and BFNPs was attributed to the enhanced light absorption and effective separation of charge carriers generated by the visible light, contributing to better photodegradation. FIG. 11C illustrates the photodegradation of MB by the SBFNPs that followed pseudo first-order kinetics, wherein the value of k was calculated from the slope of the linear plot. The calculated MB degradation rate constants for MB (blank), pure BFNPs, S₁BFNPs, S₂BFNPs, and S₃BFNPs were 0.00063 min⁻¹, 0.00308 min⁻¹, 0.00533 min⁻¹, 0.00839 min⁻¹, and 0.00642 min⁻¹, indicating that the S₂BFNPs had the largest MB photocatalytic degradation rate constant among all SBFNPs. FIG. 11D depicts the MB dye degradation of the S₂BFNPs under visible illumination for 5 consecutive cycles. After 5 test cycles, the photocatalytic efficiency of the catalyst slightly decreased from 84.20% to 80.02%, confirming the good reusability of the S₂BFNPs. The observed decrease in efficiency may be due to the catalyst loss during the regeneration process. Briefly, it was demonstrated that the S₂BFNPs is stable for environmental applications.

### Photodegradation Mechanism

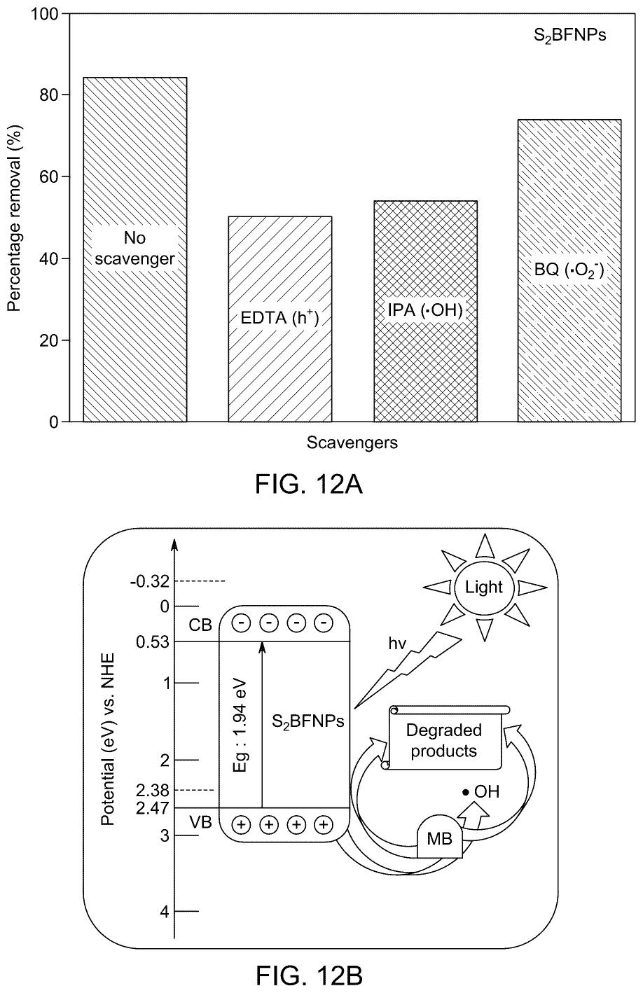

The S₂BFNPs were used in active species trapping studies to identify the primary species responsible for MB dye degradation. Several reactive species, including h⁺, ·O₂⁻, and ·OH, are involved in photocatalytic processes during organic pollutant degradation. FIG. 12A shows that the addition of BQ (·O₂⁻ scavenger) to the reaction media had minimal influence on the photocatalytic degradation of MB. The degradation efficiency was reduced when EDTA (h⁺ scavenger) was added, demonstrating that h⁺ was the primary reactive species responsible for photocatalytic activity. The addition of IPA (·OH scavenger) also reduced the degradation rate, demonstrating that ·OH played a role in the degradation process. Mulliken's electronegativity formula was used to estimate the valence band (E_{VB}) and conduction band (E_{CB}) edge potential of the S₂BFNPs (photocatalyst). These band edges determine the photogenerated carriers' isolation, generation, and transition during the degradation process. The edges of E_{VB} and E_{CB} were computed using equations 5 and 6.

E_{VB}=X−E₀+0.5E_{g} (5)

E_{CB}=EVB−E_{g} (6)

Where X is the absolute electronegativity of the material, which is 6.00 eV for BF, E₀=4.5 eV is the hydrogen scale-free electron energy, and E_{g}=1.94 eV for the S₂BFNPs. The estimated values of E_{VB} and E_{CB} were 2.47 eV and 0.53 eV, respectively. FIG. 12B shows a schematic diagram of photocatalytic MB degradation. Based on these calculations, when photons with energies equal to or higher than the S₂BFNPs bandgap are bombarded with light, electrons (e) in the E_{VB} absorb and transfer energy from the E_{VB} to the E_{CB}, generating h⁺ and e⁻ in the E_{VB} and E_{CB}, respectively. Since the potential of E_{VB} (2.47 eV) is larger than that of ·OH/H₂O, the accumulated h⁺ in E_{VB} can directly destroy MB fragments or combine with H₂O molecules adsorbed on the photocatalyst surface to form ·OH (2.38 eV). ·OH will also degrade MB into less toxic by-products, such as H₂O and CO₂; however, since the potential of ECB (0.53 eV) is greater than the O₂/·O₂⁻ redox potential (0.32 eV), the e⁻ in the ECB of the photocatalyst cannot absorb dissolved O₂ to form ·O₂⁻. As a result, h⁺ and ·OH dominate the degrading process rather than ·O₂⁻, which is consistent with the findings from the active species trapping studies. Thus, the probable photocatalytic reactions of MB dye on the S₂BFNPs can be described via the following reaction pathways (equations 7-10).

S₂BFNPs+hν→S₂BFNPs(e⁻+h⁺) (7)

h⁺+MB→degradation products (8)

h⁺+H₂O→·OH (9)·

·OH+MB→degradation products (10)

### Electrochemical Hydrogen Production and Storage Capacity

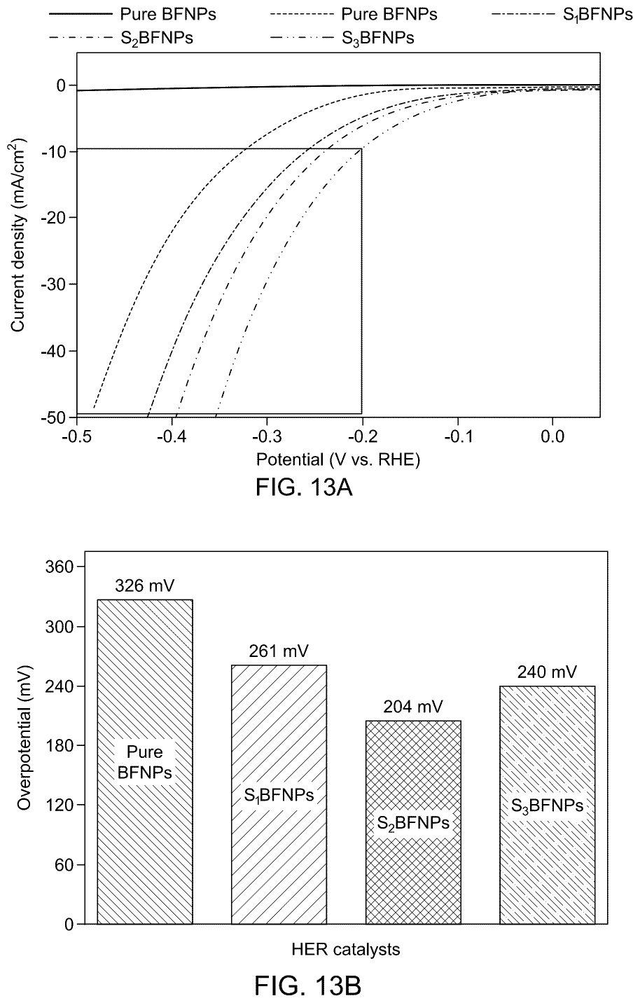

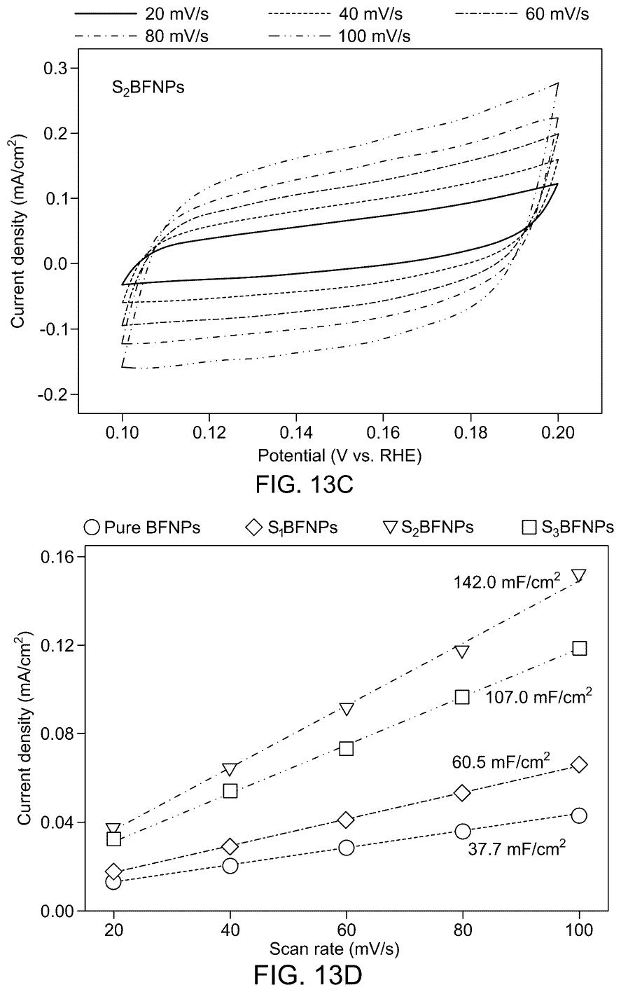

The electrochemical hydrogen production effectiveness of pure BFNPs and SBFNPs electrodes, which were modified with representative GC conducting substrates, was assessed using LSV in a standard three-electrode system in an N₂-saturated 1.0 M KOH solution with a pH of 13.6, as shown in FIG. 13A. The LSV curves were acquired by applying a scan rate of 5 mV/s after modifying the GC electrode with pure BFNPs. The modification resulted in an enhanced overpotential, reaching a value of 326 mV vs. RHE at a current density of 10 mA/cm². Furthermore, the catalytic efficiency improves when sulfur is incorporated into the BF sites, forming the SBFNPs. The incorporation of sulfur into the BF framework allows for the manipulation of sulfur's electronic configuration within the framework, thereby enhancing the efficiency of hydrogen production by serving as a catalytic center and increasing the number of active catalytic sites. The S₂BFNPs exhibit excellent catalytic activity in hydrogen production, requiring just 204 mV overpotential to reach a current density of 10 mA/cm² (FIG. 13B). This performance surpasses electrodes composed solely of pure BFNPs, S₁BFNPs, and S₃BFNPs.

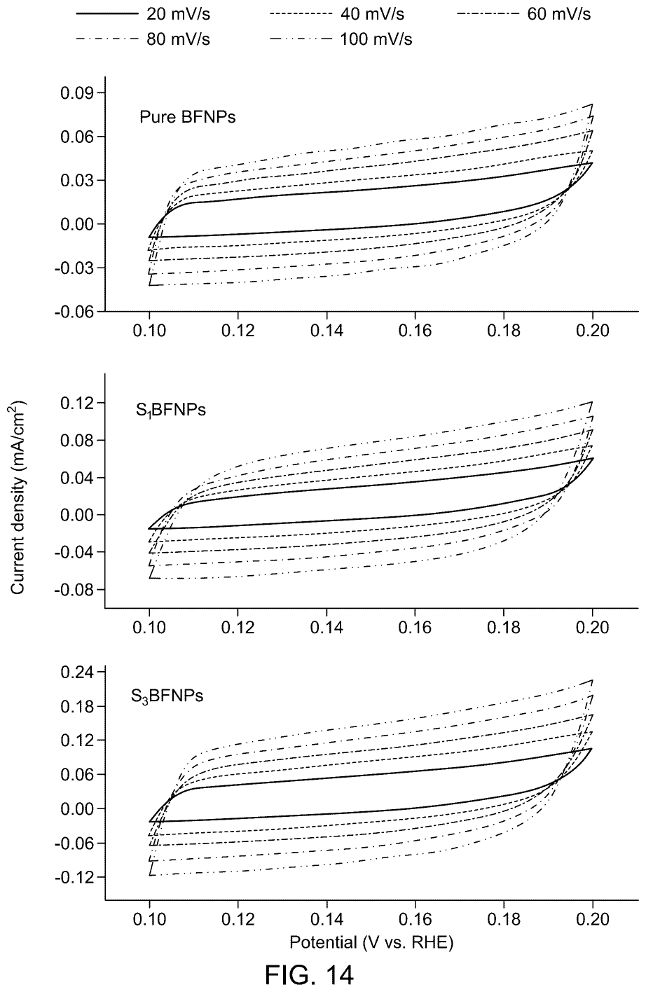

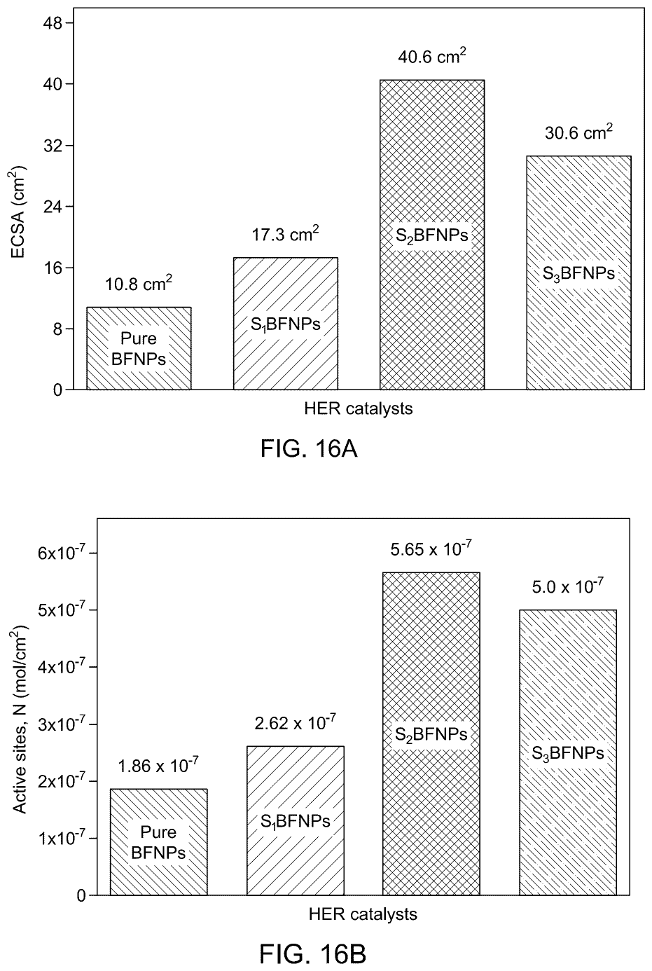

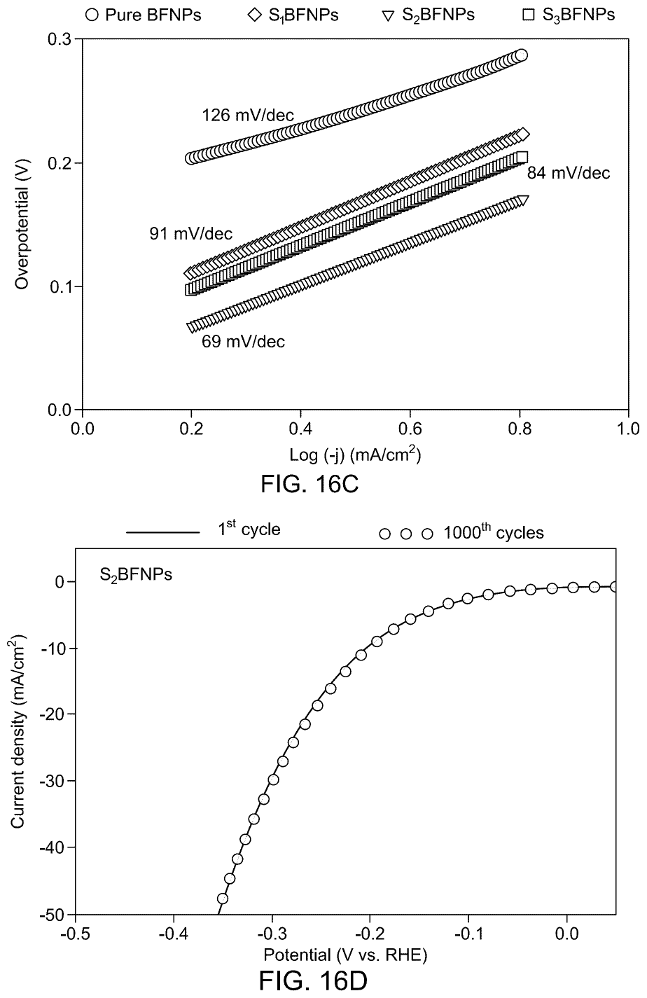

ECSA analysis was used to evaluate the hydrogen production capabilities of pure BFNPs and SBFNP electrodes. The ECSA calculation involves evaluating the Cal, which is determined by measuring the CV at different scan rates within a non-faradic region (FIG. 13C and FIG. 14). FIG. 13D shows that the S₂BFNP electrodes had the highest Cal value of 142.0 mF/cm² among the other electrodes of the same type. The observed Cal value is about 3.8-fold higher than the pure BFNPs electrode, indicating that the sulfur-encapsulated BFNPs has a considerable impact. The ECSA histogram depicted in FIG. 16A shows that encapsulating sulfur in the BFNPs electrode enhances the ECSA compared to the pure BFNPs electrode. The S₂BFNPs electrode has a higher ECSA of 40.6 cm² compared to other electrodes of similar composition. The encapsulating sulfur may alter e″ distribution and hinder surface oxidation of the BFNPs, enhancing the presence of active sites and improving the efficiency of hydrogen production. Excessive sulfur accumulation within the BFNPs may impede active sites and serve as a recombination center by causing structural and compositional changes. These findings are consistent with the LSV outcomes shown in FIG. 13A.

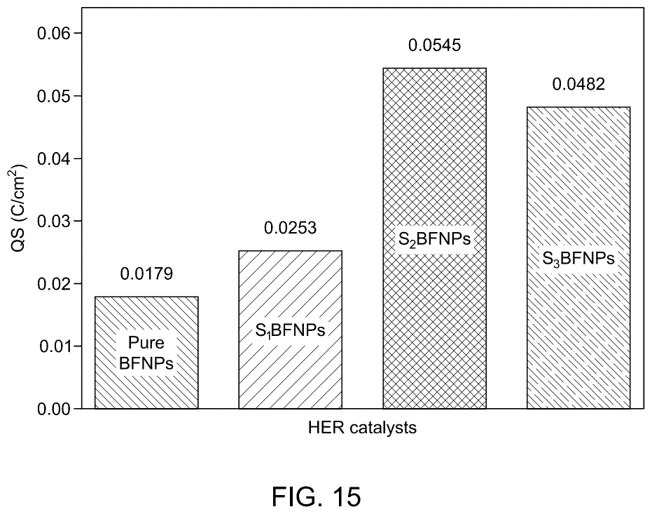

QS analysis was used to determine the N for the represented SBFNP electrodes to mitigate the influence of the catalyst's active sites. It was found that the S₂BFNPs electrode has a higher QS when compared to the pure BFNPs electrodes, with a value of 0.0545 C/cm² (FIG. 15). Consequently, the S₂BFNPs electrode exhibits a higher calculated N value of 5.65×10⁻⁷ mol/cm², as shown in FIG. 16B. These findings indicate that the S₂BFNPs electrode performs better in enhancing hydrogen production.

To thoroughly investigate the kinetics of hydrogen production on electrodes composed of pure BFNPs and SBFNPs, the Tafel slopes were analyzed and quantified using a linear regression model on the Tafel plot, which represents the relationship between the over-potential (η) and the logarithm of current-density. FIG. 16C illustrates the Tafel slope of the S₂BFNPs electrode, which was determined to be 69 mV/dec. The value is lower than the Tafel slopes recorded for pure BFNPs. This observation indicates that the former electrocatalyst exhibits superior and faster reaction kinetics. The Tafel slope increased when BFNPs electrodes were encapsulated with above 2.0% sulfur. This scrutiny may be attributed to active site inhibition, which agrees with the LSV curves shown in FIG. 13A. The Tafel slope has been widely employed to understand better the rate-limiting steps in the hydrogen production mechanism process. The Volmer, Heyrovsky, and Tafel pathways are thought to be important steps in converting hydrogen protons into molecular hydrogen. Based on the underlying mechanisms, combining the Volmer pathway with either the Heyrovsky or Tafel pathways may generate molecular hydrogen. Typically, the Volmer pathway is the rate-limiting factor when the slope is around 120 mV/dec. The Heyrovsky or Tafel pathway is considered the rate-limiting factor when the slope is around 40 or 30 mV/dec, respectively. According to the findings of the present disclosure revealed that the Tafel slopes for the S₂BFNPs electrode were 69 mV/dec, as depicted in FIG. 16C. This observation implies that the Volmer-Heyrovsky pathway mechanism is thought to be the step that controls the overall reaction rate.

In addition to its electrocatalytic activity, the electrode's long-term stability is a factor to consider when determining its suitability for practical applications. Prolonged CV evaluations on the electrocatalyst S₂BFNPs for 1000 cycles is shown in FIG. 16D. FIG. 16D shows that there was almost no change in the LSV measurement between the first and final 1000 cycles of the S₂BFNPs framework electrode. The negligible change in the potential provides further evidence for the strong stability of the S₂BFNPs material employed in hydrogen production.

The electrochemical hydrogen storage capacity performance of pure BFNPs and SBFNPs was assessed via the charge/discharge cycles using the CP method at 1.0 mA current in a 1.0 M KOH medium. In this method, H atoms were generated by the decomposition of water. In the charging process, the generated H atoms were transferred into the working electrode (absorption by the S₂BFNPs surface). In the discharging cycle, the adsorbed H atoms were desorbed from the working electrode surface and returned to the water. The process of H atom adsorption onto the working electrode surface can be described using the following reaction pathways (equations 11-13):

H₂O+e⁻→OH⁻ (11)

4OH⁻→O₂+2H₂O+4e⁻ (12)

S₂BFNPs+xH₂O+x e⁻→S₂BFNPs−xH_{ads}+OH⁻ (13)

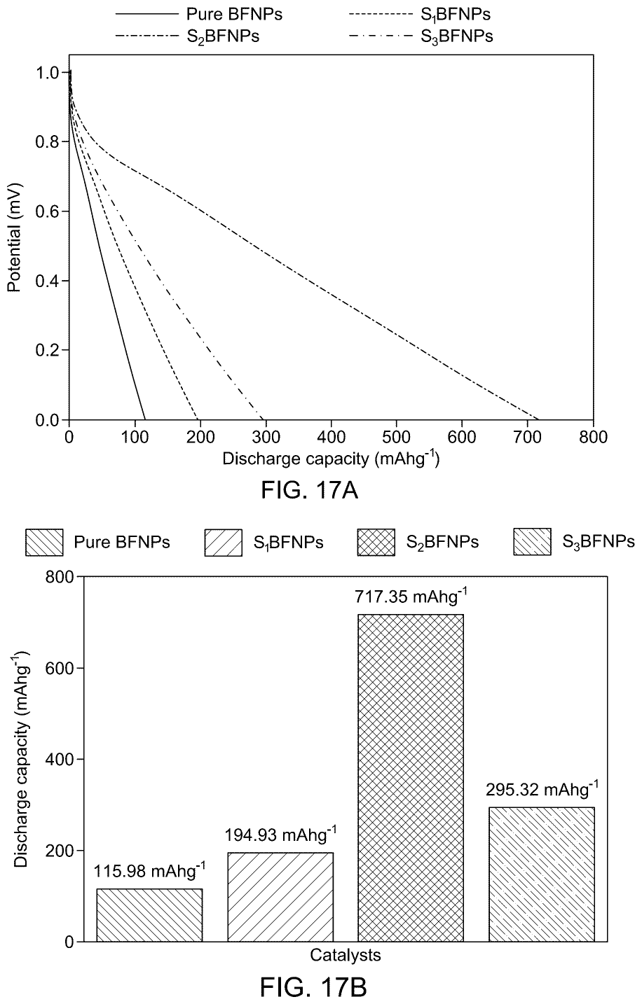

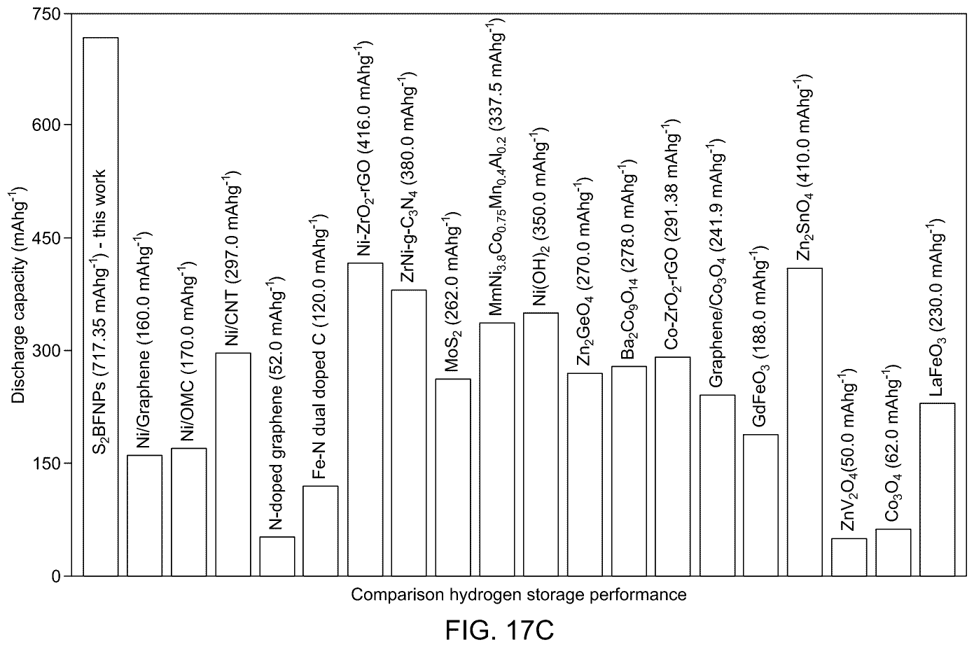

FIG. 17A compares the hydrogen discharge capacities for pure BFNPs and SBFNPs in the first cycle at 1.0 mA current in a 1.0 M KOH medium. The calculated hydrogen discharge capacity (FIG. 17B) of pure BFNPs, S₁BFNPs, S₂BFNPs, and S₃BFNPs are 115.98 mAhg⁻¹, 194.93 mAhg⁻¹, 717.35 mAhg⁻¹, and 295.32 mAhg⁻¹, respectively. The obtained discharge capacities were compared (FIG. 17C) with various materials reported [N. Liu, L. Yin, L. Kang, X. Zhao, C. Wang, L. Zhang, D. Xiang, R. Gao, Y. Qi, N. Lun, Enhanced electrochemical hydrogen storage capacity of activated mesoporous carbon materials containing nickel inclusions, Int J Hydrogen Energy. 35 (2010) 12410-12420; M. H. Choi, Y. J. Min, G. H. Gwak, S. M. Paek, J. M. Oh, A nanostructured Ni/graphene hybrid for enhanced electrochemical hydrogen storage, J Alloys Compd. 610 (2014) 231-235; X. P. Gao, Y. Lan, G. L. Pan, F. Wu, J. Q. Qu, D. Y. Song, P. W. Shen, Electrochemical hydrogen storage by carbon nanotubes decorated with metallic nickel, Electrochem Solid State Lett. 4 (2001) A173; S. S. Gunasekaran, T. K. Kumaresan, S. A. Masilamani, S. Z. Karazhanov, K. Raman, R. Subashchandrabose, Divulging the electrochemical hydrogen storage on nitrogen doped graphene and its superior capacitive performance, Mater Lett. 273 (2020) 127919; D. Qu, X. Xu, L. Zhou, W. Li, J. Wu, D. Liu, Z. Xie, J. Li, H. Tang, Electrochemical hydrogen storage in iron nitrogen dual-doped ordered mesoporous carbon, Int J Hydrogen Energy. 44 (2019) 7326-7336; M. Kaur, K. Pal, Synthesis, characterization and electrochemical evaluation of hydrogen storage capacity of graphitic carbon nitride and its nanocomposites in an alkaline environment, J Mater Sci Mater Electron. 32 (2021) 12475-12489; M. Kaur, K. Pal, Potential electrochemical hydrogen storage in nickel and cobalt nanoparticles-induced zirconia-graphene nanocomposite, J Mater Sci Mater Electron. 31 (2020) 10903-10911; H. Ma, Z. Tao, F. Gao, J. Chen, H. Yuan, Synthesis, characterization and hydrogen storage capacity of MS2 (M=Mo, Ti) nanotubes, Front Chem China. 1 (2006) 260-263; X. Zhao, Y. Ding, L. Ma, L. Wang, M. Yang, X. Shen, Electrochemical properties of MmNi3.8Co0.75Mn0.4Al0.2 hydrogen storage alloy modified with nanocrystalline nickel, Int J Hydrogen Energy. 33 (2008) 6727-6733; M. M. Arani, M. S. Niasari, Novel synthesis of Zn2GeO4/graphene nanocomposite for enhanced electrochemical hydrogen storage performance, Int J Hydrogen Energy. 42 (2017) 17184-17191; W. K. Hu, D. Noréus, Alpha nickel hydroxides as lightweight nickel electrode materials for alkaline rechargeable cells, Chem Mater. 15 (2003) 974-978; M. Kaur, K. Pal, Potential electrochemical hydrogen storage in nickel and cobalt nanoparticles-induced zirconia-graphene nanocomposite, J Mater Sci Mater Electron. 31 (2020) 10903-10911; Y. Chen, Q.

Wang, C. Zhu, P. Gao, Q. Ouyang, T. Wang, Y. Ma, C. Sun, Graphene/porous cobalt nanocomposite and its noticeable electrochemical hydrogen storage ability at room temperature, J Mater Chem. 22 (2012) 5924-5927; R. Mohassel, M. S. Nooshabadi, M. S. Niasari, Effect of g-C3N4 amount on green synthesized GdFeO3/g-C3N4 nanocomposites as promising compounds for solid-state hydrogen storage, Int J Hydrogen Energy. 48 (2023) 6586-6596; F. S. Razavi, M. H. Oghaz, O. Amiri, M. S. Morassaei, M. S. Niasari, Barium cobaltite nanoparticles: Sol-gel synthesis and characterization and their electrochemical hydrogen storage properties, Int J Hydrogen Energy. 46 (2021) 886-895; M. M. Arani, M. S. Niasari, Facile precipitation synthesis and electrochemical evaluation of Zn2SnO4 nanostructure as a hydrogen storage material, Int J Hydrogen Energy. 42 (2017) 12420-12429; F. K. Butt, M. Tahir, C. Cao, F. Idrees, R. Ahmed, W. S. Khan, Z. Ali, N. Mahmood, M. Tanveer, A. Mahmood, Synthesis of novel ZnV2O4 hierarchical nanospheres and their applications as electrochemical supercapacitor and hydrogen storage material, ACS Appl Mater Interfaces. 6 (2014) 13635-13641; Y. Pei, W. Du, Y. Li, W. Shen, Y. Wang, S. Yang, S. Han, The effect of carbon-polyaniline hybrid coating on high-temperature electrochemical performance of perovskite-type oxide LaFeO3 for MH-Ni batteries, Phys Chem Chem Phys. 17 (2015) 18185-18192; G. X. Pan, X. H. Xia, F. Cao, J. Chen, Y. J. Zhang, Template-free synthesis of hierarchical porous Co304 microspheres and their application for electrochemical energy storage, Electrochim Acta. 173 (2015) 385-392, which are incorporated herein by reference in their entireties]. Using Faraday's rule, the obtained values of charge capacity for 1.0 wt. % of hydrogen corresponded to 270 mAhg⁻¹. The calculated hydrogen storage capacity of pure BFNPs, S₁BFNPs, S₂BFNPs, and S₃BFNPs were 0.43 wt. %, 0.72 wt. %, 2.66 wt. %, and 1.09 wt. %, respectively. The S₂BFNPs had the maximum hydrogen storage capacity among all the SBFNPs. The observed improvement in the electrochemical hydrogen production and storage performance of the SBFNP materials (used as a working electrode) were attributed to the synergistic effects of sulfur and Bi⁰ and Fe⁰ in the BENPs framework.

Bi⁰/Fe⁰-rich pure BFNPs and sulfur-encapsulated BFNPs (SBFNPs) materials were prepared using a probe sonication approach. XRD analysis of the SBFNPs indicated the existence of a crystalline structure composed of dual Bi⁰/Fe⁰-rich with a sulfur content encapsulating the BFNPs materials. The FTIR spectra of the prepared SBFNPs confirmed the presence of metal-S bond functional units. The SEM and TEM images of the SBFNPs framework revealed their irregular morphology. The XPS spectra confirmed the successful encapsulation of dual Bi⁰/Fe⁰-rich materials, along with the presence of sulfur, within the SBFNPs. The sulfur-encapsulation in the BENPs influenced the optical E_{g} of the SBFNPs, causing the value to decrease from 2.40 eV to 1.94 eV. The recombination of charge carriers in the SBFNPs was confirmed through PL spectral analysis. The synthesized SBFNPs exhibited enhanced photocatalytic efficiency against degrading MB dye solution. The sulfur (2.0%) encapsulated BFNPs (S₂BFNPs) demonstrated the highest adsorption capacity and photocatalytic activity following 120 minutes of light exposure. The active species, recyclability, and stability tests have confirmed the optimal characteristics of the S₂BFNPs. A feasible charge transfer process was proposed to explain the increased photodegradability of the synthesized SBFNPs. In addition, the catalytic activity of pure BFNPs and SBFNPs demonstrated that the S₂BFNP electrocatalyst displays good hydrogen production and storage capacity performance. This is evident from its low overpotential (204 mV), small Tafel slope (69 mV/dec), higher C_{dl} (142.0 mF/cm²), higher ECSA (40.6 cm²), abundant catalytic active sites (5.65×10⁻⁷ mol/cm²), and excellent stability, all of which contribute to enhancing the hydrogen production process. The S₂BFNPs exhibited a maximum discharge capacity of 717.35 mAhg⁻¹ and a hydrogen storage capacity of 2.66 wt. %. It is recognized that the synergistic of sulfur, dual Bi⁰/Fe⁰-rich in the BENPs has resulted in the customized photo-catalytic and electrochemical performance of the SBFNPs. The suggested new type of dual Bi⁰/Fe⁰-rich in sulfur-encapsulated BFNPs using a probe sonic approach may benefit various applications such as visible light photocatalysis, hydrogen production, and storage devices. These applications will contribute to the growth of renewable energy production and environmental sustainability in the future.

Numerous modifications and variations of the present disclosure are possible in light of the above teachings. It is therefore to be understood that within the scope of the appended claims, the invention may be practiced otherwise than as specifically described herein.

1: Bismuth ferrite nanoparticles, comprising:
Bi₂Fe₄O₉ nanoparticles doped with Fe(0) and Bi(0); and
sulfur in an amount of 0.5 to 5 percent by weight,
wherein at least a portion of bismuth is bonded to at least a portion of the sulfur and at least a portion of iron is bonded to at least a portion of the sulfur,
wherein the bismuth ferrite nanoparticles have a longest dimension of 1 to 50 nm.

2: The bismuth ferrite nanoparticles of claim 1, comprising bismuth in an oxidation state of Bi(0), Bi(III), and Bi(V).

3: The bismuth ferrite nanoparticles of claim 1, comprising iron in an oxidation state of Fe(0), Fe(II), and Fe(III).

4: The bismuth ferrite nanoparticles of claim 1, wherein the bismuth ferrite nanoparticles are encapsulated with the sulfur.

5: The bismuth ferrite nanoparticles of claim 1, wherein the bismuth ferrite nanoparticles have a direct band gap (E_{g}) value of 1.9 to 2.3 eV.

6: The bismuth ferrite nanoparticles of claim 1, wherein the bismuth ferrite nanoparticles are made by a process comprising:
dissolving bismuth and iron in an acid solution to form a first mixture;
stirring the first mixture;
adding a sulfur salt to the first mixture to form a second mixture;
sonicating the second mixture to form a product;
centrifuging and washing the product;
drying the product at 60 to 100° C. for 10 to 15 hours; and
calcinating the product at 500 to 700° C. for 3 to 5 hours to form the bismuth ferrite nanoparticles.

7: A method of photocatalytic dye degradation, comprising:
contacting a dye solution with the bismuth ferrite nanoparticles of claim 1 to form a reaction mixture,
wherein the dye solution comprises at least one dye,
agitating the reaction mixture in a dark condition for a time sufficient to expose the dye to the bismuth ferrite nanoparticles; and
irradiating the reaction mixture with a light for a time sufficient to degrade the at least one dye.

8: The method of claim 7, wherein the at least one dye is methylene blue.

9: The method of claim 8, wherein a degradation rate constant is from 0.005 to 0.009 min⁻¹.

10: The method of claim 7, wherein a degradation of the at least one dye is from 80 to 90 percent by weight based on an initial weight of the dye.

11: The method of claim 7, further comprising:
agitating the reaction mixture in the dark condition and irradiating the reaction mixture with the light for at least 5 consecutive cycles to degrade the at least one dye.

12: The method of claim 11, wherein a degradation rate of the at least one dye after the at least 5 consecutive cycles is 93 to 97 percent of an initial degradation rate.

13: The method of claim 7, wherein holes of electron-hole pairs are a reactive species in a degradation pathway of the at least one dye.

14: A method of hydrogen storage, comprising:
connecting a working electrode, a reference electrode, and a counter electrode with a potentiostat,
wherein the working electrode is the bismuth ferrite nanoparticles of claim 1 on a graphitic carbon,
contacting the working electrode, the reference electrode, and the counter electrode with an aqueous electrolyte solution;
applying a potential; and
generating and storing hydrogen at the working electrode.

15: The bismuth ferrite nanoparticles of claim 1, wherein the bismuth ferrite nanoparticles have an overpotential of 200 to 270 mV at a current density of 10 mA/cm².

16: The bismuth ferrite nanoparticles of claim 1, wherein the bismuth ferrite nanoparticles have a double layer capacitance (C_{dl}) value of 60 to 145 mF/cm².

17: The bismuth ferrite nanoparticles of claim 1, wherein the bismuth ferrite nanoparticles have a surface charge density of 0.02 to 0.06 C/cm².

18: The bismuth ferrite nanoparticles of claim 1, wherein the bismuth ferrite nanoparticles have a Tafel slope of 65 to 95 mV/dec.

19: The bismuth ferrite nanoparticles of claim 1, wherein the bismuth ferrite nanoparticles have a hydrogen storage capacity of 0.5 to 3.0 wt. % based on a total weight of the bismuth ferrite nanoparticles.

20: The bismuth ferrite nanoparticles of claim 1, wherein the bismuth ferrite nanoparticles have a discharge capacity of 190 to 720 mAh/g.
